(19) United States
(12) Patent Application Publication
(10) Pub. No.: US 2016/0173840 A1
(43) Pub. Date: Jun. 16, 2016

(54) INFORMATION OUTPUT CONTROL DEVICE

(71) Applicant: CASIO COMPUTER CO., LTD., Tokyo (JP)

(72) Inventor: Shigeo KURAKAKE, Hanno-shi (JP)

(73) Assignee: CASIO COMPUTER CO., LTD., Tokyo (JP)

(21) Appl. No.: 14/864,024

(22) Filed: Sep. 24, 2015

(30) Foreign Application Priority Data
Dec. 10, 2014 (JP) 2014-249707
Dec. 10, 2014 (JP) 2014-249737
Dec. 10, 2014 (JP) 2014-249741

(51) Int. Cl. H04N 9/31; G06T 7/00

(52) U.S. Cl. CPC H04N 9/3185; H04N 9/3194; G06T 7/004

(57) ABSTRACT

An object is to appropriately control the output of display information based on to which display target the display information is directed and in which area the display target is present. An information output control device includes a display information memory for storing display information in association with a display target such as electronic paper which is present outside the device. When a display target present in a predetermined area such as a projectable area is recognized and identified, display information associated with the display target is read out and acquired from the display information memory, the position of the display target present in the predetermined area is acquired, and the acquired display information is outputted such that it is displayed in association with the display target present at the acquired position.

### CROSS-REFERENCE TO RELATED APPLICATIONS

This application is based upon and claims the benefit of priority from the prior Japanese Patent Applications No. 2014-249707, filed Dec. 10, 2014, No. 2014-249737, filed Dec. 10, 2014 and No. 2014-249741, filed Dec. 10, 2014, the entire contents of which are incorporated herein by reference.

### BACKGROUND OF THE INVENTION

1. Field of the Invention

The present invention relates to an information output control device which outputs display information.

2. Description of the Related Art

A general example of an information output control device which outputs display information is a projector device for the projection display of an image on an external projection target (display target: screen) by a light source, a transmission-type liquid-crystal panel, and the like. In cases where such a projector device is used to project various references (images) on a display target (screen) for presentation, a presenter or the like indicates a necessary point on the screen while orally providing auxiliary descriptions, information to be noticed, and the like in accordance with the references on the screen. In a conventionally known technology, in these cases, the indication trajectory of a pen on an image being projected is projected on the image (refer to Japanese Patent Application Laid-Open (Kokai) Publication No. 2003-078686). Also, a technology related to projection is known in which an image is projected on a moving target by projection mapping (refer to Japanese Patent Application Laid-Open (Kokai) Publication No. 2013-192189).

However, the technology disclosed in Japanese Patent Application Laid-Open (Kokai) Publication No. 2003-078686 in which the screen of an electronic blackboard is taken as a projection target is merely a technology where a point operated by a pen on a device is identified. Accordingly, projection targets and the contents of display information to be projected and displayed are not specified. Similarly, in the technology disclosed in Japanese Patent Application Laid-Open (Kokai) Publication No. 2013-192189 in which the change of the position or shape of a display target is checked and then projected and displayed, targets and the contents of display information to be projected and displayed are not specified. This problem occurs in not only projector devices but also other information output control devices.

### SUMMARY OF THE INVENTION

A first object of the present invention is to appropriately control display information based on which display target the display information is directed to and in which area the display target is present.

A second object of the present invention is to reproduce and output information inputted by associating an output target with a predetermined area where the output target is placed, on condition of this association.

The present invention has been conceived in light of the above-described problems. In accordance with one aspect of the present invention, there is provided an information output control device which outputs display information, comprising: a display information storage section which stores display information in association with a display target which is present outside the information output control device; an identifying section which identifies the display target which is present in a predetermined area; a first acquiring section which reads out and acquires the display information associated with the display target identified by the identifying section, from the display information storage section; a second acquiring section which acquires a position of the display target present in the predetermined area; and a display control section which controls output of the display information such that the display information acquired by the first acquiring section is displayed in association with the display target present at the position acquired by the second acquiring section.

In accordance with another aspect of the present invention, there is provided an information output control device which outputs information, comprising: an input information acquiring section which acquires input information; an identifying section which identifies a predetermined output target placed in a predetermined area outside the information output control device; an information storage section which stores the input information acquired by the input information acquiring section while the output target identified by the identifying section is present in the predetermined area, in association with the output target; and an output control section which reads out the input information stored in association with the output target from the information storage section, and performs reproduction output of the input information, when the output target is placed again in the predetermined area.

In accordance with another aspect of the present invention, there is provided an information display control device which controls display in a predetermined area, comprising: a display information storage section which stores display information in association with a display target which is present outside the information display control device; an identifying section which identifies the display target placed on a display device in the predetermined area; an acquiring section which reads out and acquires the display information associated with the display target identified by the identifying section, from the display information storage section; and a display control section which controls display on the display device such that the display information acquired by the acquiring section is displayed at a position near the display target.

According to the present invention, display information can be appropriately controlled based on which display target the display information is directed to and in which area the display target is present.

Also, according to the present invention, information inputted by associating an output target with a predetermined area where the output target is placed can be reproduced and outputted on condition of this association.

### BRIEF DESCRIPTION OF THE DRAWINGS

FIG. 1 is a diagram showing an example of use of a projector device having a camera function, in which the present invention has been applied as an information output control device;

FIG. 2 is a block diagram showing basic components of the camera-function-equipped projector device;

FIG. 3A to FIG. 3G are diagrams for describing projection contents displayed in association with electronic paper 3 placed in a projectable area 2a;

FIG. 4A is a diagram for describing a display information memory M3;

FIG. 4B is a diagram for describing a display position memory M4;

FIG. 5 is a flowchart for describing an operation of a camera-equipped projector device 1 which is started upon power up;

FIG. 6 is a flowchart following the operation of FIG. 5;

FIG. 7 is a flowchart following the operation of FIG. 5;

FIG. 8A to FIG. 8C are diagrams for describing projection contents displayed in association with the electronic paper 3 placed in the projectable area 2a when “near electronic paper” is selected as a display position for projection display;

FIG. 9 is a diagram showing an example of use of a projector device having a camera function in a second embodiment, in which the present invention has been applied as an information output control device;

FIG. 10 is a block diagram showing basic components of the camera-function-equipped projector device;

FIG. 11A to FIG. 11E are diagrams for describing projection contents and a voice input/output status displayed in association with electronic paper 3 placed in a projectable area 2;

FIG. 12 is a diagram for describing an output information memory M5;

FIG. 13 is a flowchart for describing an operation (characteristic operation of the second embodiment) of a camera-equipped projector device which is started upon power up;

FIG. 14 is a flowchart following the operation of FIG. 13;

FIG. 15 is a diagram showing an example of use of an information output control device (notebook PC) 100 in a third embodiment;

FIG. 16 is a block diagram showing basic components of the notebook PC 100, a display device 200, and a portable terminal device 300 in the third embodiment;

FIG. 17A to FIG. 17D are diagrams for describing display contents in the third embodiment when the portable terminal device 300 is placed on the display device 200;

FIG. 18 is a diagram for describing an output information memory M5 of the third embodiment;

FIG. 19 is a flowchart that is started when “display device control mode” for controlling display on the display device 200 is selected in the third embodiment; and

FIG. 20 is a flowchart following the operation of FIG. 19.

### DETAILED DESCRIPTION OF THE PREFERRED EMBODIMENTS

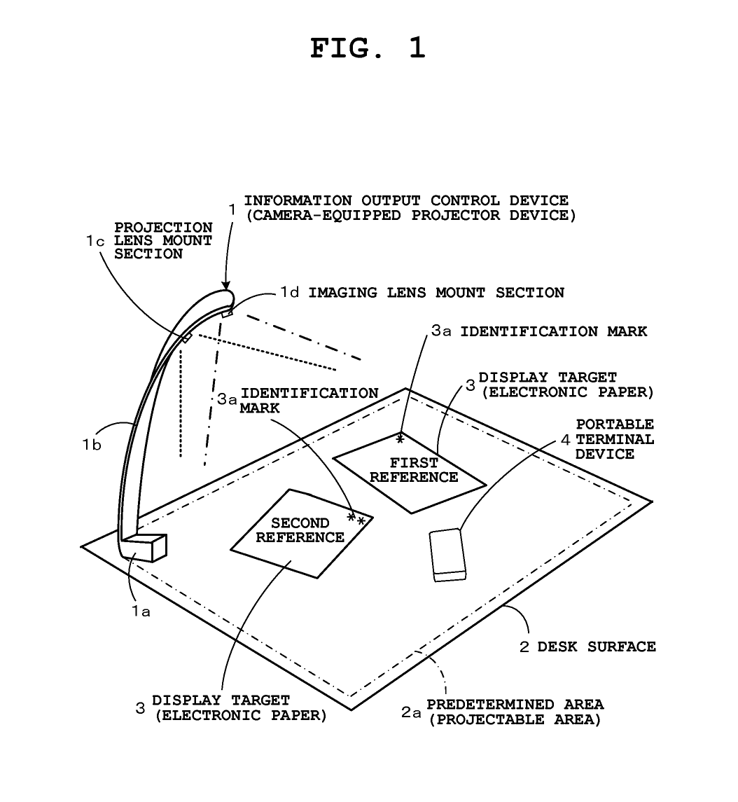

Hereafter, a first embodiment of the present invention is described with reference to FIG. 1 to FIG. 8C.

In the first embodiment, the present invention has been applied in a camera-equipped projector device as an information output control device which outputs display information. FIG. 1 is a diagram showing an example of use of this camera-function-equipped projector device.

The information output control device (camera-equipped projector device) 1 has a projector function, a camera (imaging) function, a communication function, and the like. The projector device 1 is, for example, a standing-type device structured to be mountable on a desk surface 2 in a meeting room or the like, and has a base 1a from which a standing arm section 1b extends. At a portion near the tip of the standing arm section 1b, a projection lens mount section 1c and an imaging lens mount section 1d are arranged.

The information output control device (camera-equipped projector device) 1 applies light in accordance with display information from above onto a display target (projection target: electronic paper 3) that is present on the desk surface 2, or images the electronic paper 3 from above. In the shown example, the camera-equipped projector device 1 has been placed at a corner on the desk surface 2 under the environment of a meeting room or the like. On the desk surface 2, the electronic paper 3, a portable terminal device 4, and the like have been placed, and meeting attendees are having a meeting while viewing display contents (reference) on the electronic paper 3. The information terminal device 4 is an example of belongings other than the electronic paper 3 incidentally arranged on the desk surface 2. Another example of the belongings other than the electronic paper 3 is an writing instrument. By analyzing an image acquired by imaging the desk surface 2, the projector device 1 distinguishes between the electronic paper 3 and the other belongings.

The electronic paper 3 is a display target when unique display information in association therewith is displayed, that is, a projection target (display target) that is present outside the projector device 1. The display information, which serves as a reference for the meeting, includes confidential information such as personal information and real-time information such as stock prices and sales status, and are projected and displayed on the electronic paper 3 from the projector device 1. That is, as will be described in detail later, when the electronic paper 3 is placed in a predetermine area (an area indicated by a one-dot-chain line in the drawing: projectable area) 2a on the desk surface 2, the projector device 1 controls the output of display information stored in association with the electronic paper 3 in advance such that the display information is displayed in association with the electronic paper 3 in the projectable area 2a. When the electronic paper 3 is moved away from the projectable area 2a, the projector device 1 performs control such that projection display of the display information is deleted.

The electronic paper 3 is constituted by, for example, microcapsule-type electronic paper (electrophoretic display) using an electrophoretic phenomenon, and has a number of media filled with colored charged particles (charged objects) arranged between a pair of opposing electrodes. When voltage is applied between the paired electrodes, the charged particles within this media move in a direction corresponding to the applied voltage so that display is performed.

In the shown example, electronic paper 3 for displaying a first reference and electronic paper 3 for displaying a second reference have been placed on the desk surface 2. Each electronic paper 3 is of an A4 size, and has an identification mark(s) (for example, an asterisk mark(s)) 3a printed on a portion (for example, the upper-right corner) thereof for identifying the electronic paper. By analyzing an image of each electronic paper 3 having the identification mark(s) 3a captured from above, the projector device 1 recognizes the electronic paper 3 having the identification mark(s) 3a as electronic paper 3 serving as a projection target, and distinguishes between these pieces of electronic paper 3 as a first reference and a second reference based on the number of identification marks 3a. That is, the projector device 1 recognizes the electronic paper 3 as a first reference when the number of identification marks 3a thereon is “1”, and recognizes the electronic paper 3 as a second reference when the number of identification marks 3a thereon is “2”.

When no identification mark 3a is on the electronic paper 3, the projector device 1 recognizes this electronic paper 3 as an object other than the electronic paper 3 (an object other than a display target) even if it is electronic paper 3. When, for example, electronic paper 3 having different contents are distributed to respective departments in a company, and electronic paper 3 dedicated to one department is placed in the projectable area 2a of the projector device 1 installed in this department, the projector device 1 performs projecting operation for this electronic paper 3. However, when electronic paper 3 dedicated to another department is placed, the projector device 1 recognizes this electronic paper 3 as an object other than a display target, and does not perform projecting operation. In this case, the identification marks 3a of these pieces of electronic paper 3 are required to have different shapes for each department, such as an asterisk shape and a circle shape.

The projectable area 2a on the desk surface 2 is an area where an image can be captured. When the electronic paper 3 is recognized to be present in the projectable area 2a by the analysis of an image acquired by imaging the projectable area 2a, the projector device 1 starts an operation of projecting and displaying display information unique to the electronic paper 3 in association with the electronic paper 3. Note that the projector device 1 has a function for, when the position of the electronic paper 3 is identified from an image acquired by imaging the projectable area 2a, adjusting a projecting direction (applying direction) to the direction of this position.

That is, the projector device 1 has a projecting direction adjusting function (omitted in the drawing). By driving an optical system in accordance with the position of the electronic paper 3, the projecting direction can be freely adjusted within the range of the projectable area 2a. Also, when a projecting operation on the electronic paper 3 present in the projectable area 2a is started, the projector device 1 monitors whether the electronic paper 3 has been moved away from the projectable area 2a to be outside this area, by analyzing an image of the projectable area 2a. Then, when the electronic paper 3 is detected to have been moved away from this area, the projector device 1 stops the projecting operation on the electronic paper 3 (deletes projection display), as described above.

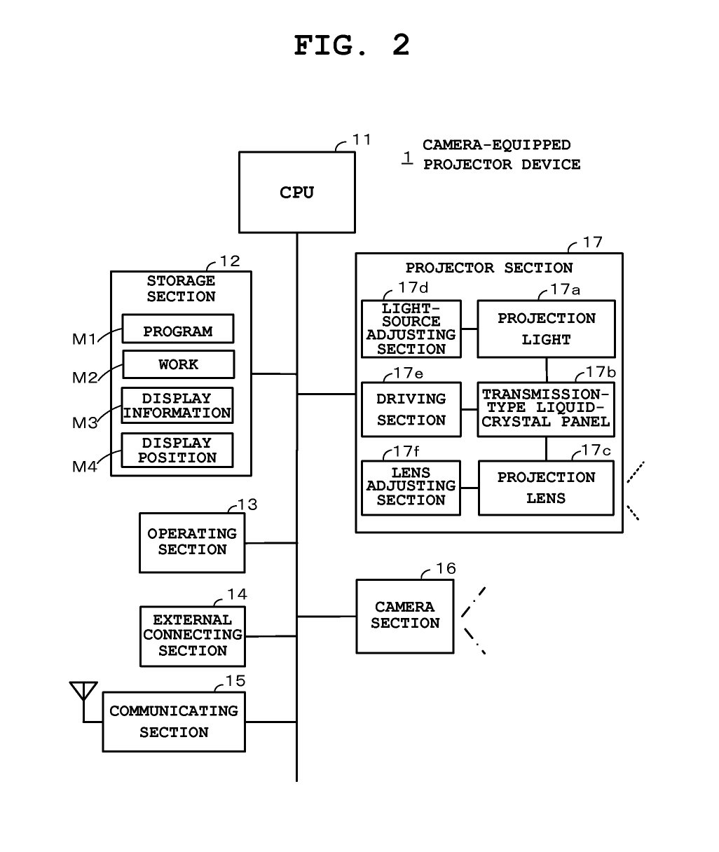

FIG. 2 is a block diagram showing basic components of the information output control device (camera-equipped projector device) 1.

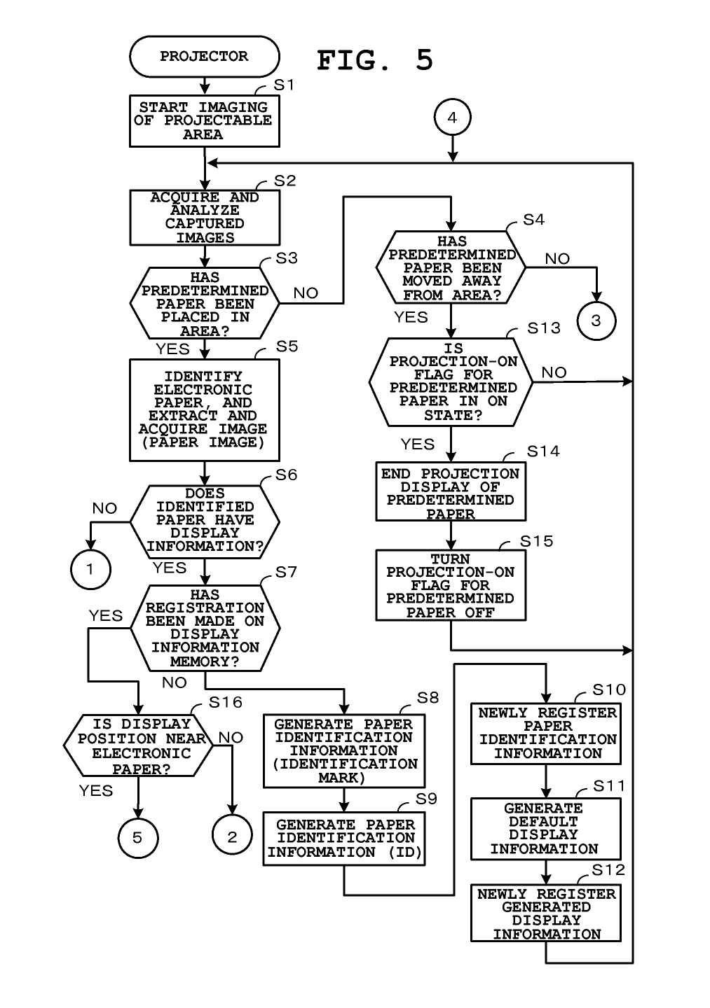

The projector device 1 has a CPU 11 as a main component. This CPU 11 is a central processing unit that controls the entire operation of the projector device 1 by following various programs in a storage section 12. The storage section 12 is constituted by, for example, a ROM (Read-Only Memory), a flash memory, and the like, and has a program memory M1 that stores a program for achieving the present embodiment in accordance with an operation procedure depicted in FIG. 5 to FIG. 7, a work memory M2 that temporarily stores various data (such as clock time, timer measurement time, and flag) required in the projector device 1, a display information memory M3, and a display position memory M4, and the like. Note that the storage section 12 may be structured to include a detachable portable memory (recording media) such as an SD (Secure Digital) card or an IC (Integrated Circuit) card. Although not depicted, in a case where the storage section 12 is connected to a network by a communication function, the storage section 12 may include a storage area on the side of a predetermined server apparatus.

The CPU 11 has an operating section 13, an external connecting section 14, a communicating section 15, a camera section 16, a projector section 17, and the like connected thereto as input/output devices. This CPU 11 controls each of the input/output devices by following an input/output program. The operating section 13 has a power supply button, a projection adjustment button, and the like. The external connecting section 14 is a connector section to which an external device (omitted in the drawing) such as a personal computer (PC) and a recording medium is connected. The communicating section 15 is a communication interface connected for communication with an external device by, for example, wireless LAN (Local Area Network) or Bluetooth (registered trademark) communication.

The camera section 16 constitutes the above-described imaging function, and has a lens mirror block including an imaging lens and a mirror, an image-pickup element, and its driving system, as well as a distance-measuring sensor, a light-amount sensor, an analog processing circuit, a signal processing circuit, a compression/decompression circuit, and the like omitted in the drawing. Also, the camera section 16 has an autofocus function for automatic focusing, a zoom function for controlling an imaging range, and the like. The projector section 17 constitutes the above-described projector function, and includes a projection light 17a for lighting up when power supply is received, a transmission-type liquid-crystal panel 17b where an image of a projection target is displayed, a projection lens 17c, a light-source adjusting section 17d which controls the projection light 17a to be turned on or off and controls the luminance thereof, a driving section 17e which drives the transmission-type liquid-crystal panel 17b, and a lens adjusting section 17f which adjusts the focus, zoom, and the like of the projection lens 17c. The optical axis direction of the imaging lens of the camera section 16 coincides with the optical axis direction of the projection lens 17c, whereby the above-described projectable area 2a can be imaged.

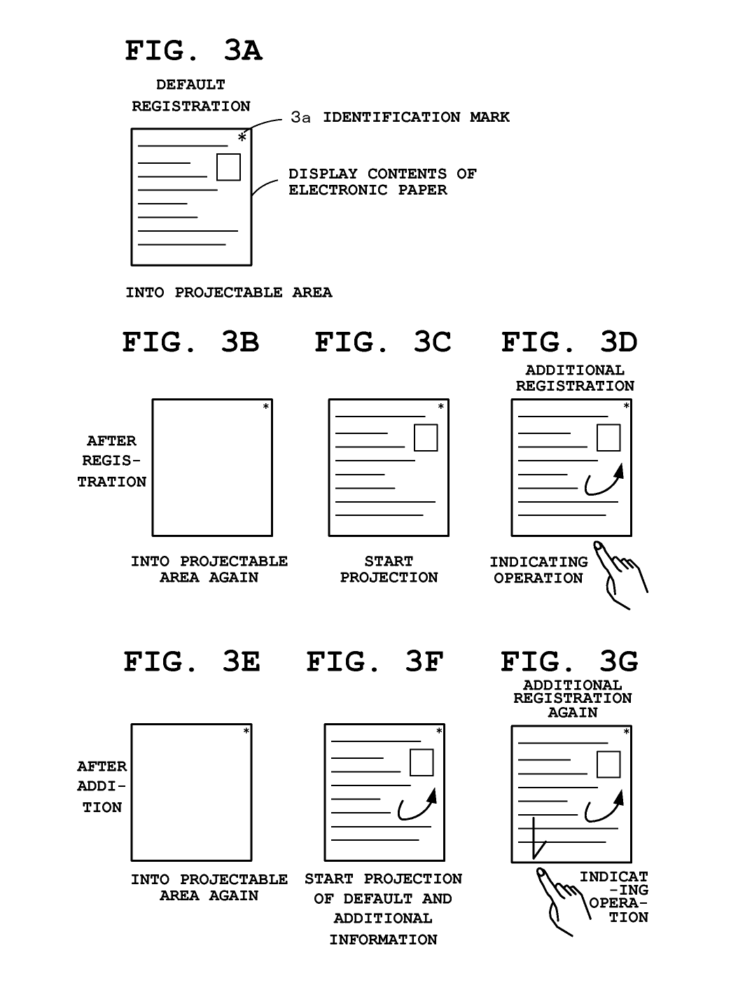

FIG. 3A to FIG. 3G are diagrams for describing projection contents displayed in association with the electronic paper 3 placed in the projectable area 2a.

FIG. 3A is a diagram showing a state where the electronic paper 3 itself is displaying information. When the electronic paper 3 displaying information is placed in the projectable area 2a on the desk surface 2, the projector device 1 extracts the display information of the electronic paper 3 from an image captured by the camera section 16 and registers the extracted display information in the display information memory M3 as default information.

FIG. 3B is a diagram showing a state where the electronic paper 3 has been placed again in the projectable area 2a on the desk surface 2 with its display information being deleted after being registered. Here, the electronic paper 3 to be placed again may be displaying some display information (the same applies hereinafter). However, when the electronic paper 3 which is not displaying any information as depicted in FIG. 3B is placed again in the projectable area 2a, the projector device 1 recognizes the electronic paper 3, and reads out display information associated with this electronic paper 3 (default display information) from the display information memory M3 for projection display. FIG. 3C is a diagram exemplifying a state where the default display information has been projected and displayed on the electronic paper 3.

FIG. 3D is a diagram of an indication trajectory when an indicating operation (any indicating operation with a finger, pen, or the like) on the electronic paper 3 is performed with the default display information being projected and displayed on the electronic paper 3 as depicted in FIG. 3C. The projector device 1 generates, as additional information, an indication trajectory from an image of an indicating operation captured by the camera section 16, additionally registers this additional information as display information on the display information memory M3, and causes the display information including the additional information to be projected and displayed on the electronic paper 3.

In FIG. 3D, the additional information in this case has been projected and displayed. The movement of the indicating operation may be three-dimensionally captured by a plurality of camera sections 16 being provided.

FIG. 3E is a diagram of a case when, for example, the electronic paper 3 which is not displaying any information is placed again in the projectable area 2a after the above-described addition. When the electronic paper 3 which is not displaying any information as depicted in FIG. 3E is placed, the projector device 1 recognizes this electronic paper 3, and reads out its display information (default display information and additional display information) from the display information memory M3 for projection display.

FIG. 3F is a diagram showing a state where the default display information and the additional display information have been combined as display information, and then projected and displayed on the electronic paper 3.

FIG. 3G is a diagram exemplifying a case where another indicating operation is further performed in the display state of FIG. 3F. In this case, the display information including newly added information is projected and displayed.

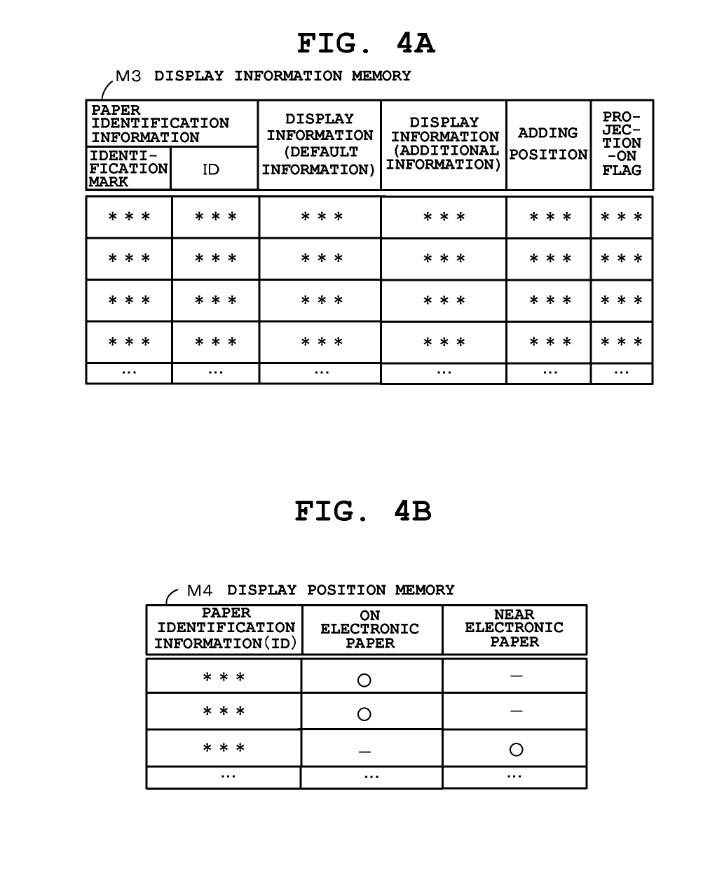

FIG. 4A is a diagram for describing the display information memory M3.

The display information memory M3, which stores and manages display information in association with a plurality of display targets (electronic paper 3), has items of “paper identification information”, “display information (default information)”, “display information (additional information)”, “adding position”, and “projection-ON flag”. “Paper identification information” is information for identifying each electronic paper 3 and includes items of “identification mark” and “ID”. “Identification mark” indicates the area of the identification mark (for example, asterisk mark) 3a printed at the upper-right corner of the electronic paper 3, which is an image of the identification mark extracted from an image acquired by the projectable area 2a on the desk surface 2 being captured. “ID” includes data of a numerical value string (for example, a serial number) generated as data for the identification of the electronic paper 3.

“Display information (default information)” indicates display information displayed on the electronic paper 3 as default information, which is an image acquired by the display information of the electronic paper 3 being extracted from a captured image of the projectable area 2a. “Display information (additional information)” indicates information corresponding to an indication trajectory additionally registered as display information when an indicating operation is performed on the electronic paper 3 as depicted in FIG. 3D. If a plurality of additions is performed, pieces of additional information for these additions are registered. “Adding position” indicates a position of addition on the electronic paper 3, and “display information (additional information)” is projected and displayed at this position. “Projection-ON flag” is a flag indicating that projection display is being performed in association with the electronic paper 3.

When identifying the electronic paper 3 placed in the projectable area 2a on the desk surface 2 by image recognition, the projector device 1 reads out display information associated with the electronic paper 3 from the display information memory M3, detects the position of the electronic paper 3 in the projectable area 2a, and projects and displays the display information in association with the electronic paper 3 at this detected position (on the electronic paper 3 or at a position nearby). Here, whether to project and display the display information on the electronic paper 3 or at a nearby position is determined by referring to the display position memory M4.

FIG. 4B is a diagram for describing the display position memory M4.

The display position memory M4 stores and manages information indicating the display position of display information on the electronic paper 3 arbitrarily selected by a user operation when the display information is projected and displayed. The display position memory M4 has items of “paper identification information (ID)”, “on electronic paper”, and “near electronic paper”. “Paper identification information (ID)” is provided to store and manage a display position for each electronic paper 3, and is linked to “ID” of “paper identification information” in the display information memory M3. “On electronic paper” is a selectable display position item, which indicates that display information is projected and displayed on the electronic paper 3 as in, for example, FIG. 3C and FIG. 3F. “Near electronic paper” is another selectable display position item, which indicates that display information is projected and displayed at a position near the electronic paper 3 (for example, a position near an upper portion of the electronic paper 3).

Each circle mark in FIG. 4B indicates an item selected as a display position. That is, they are information indicating which one of “on electronic paper” and “near electronic paper” has been selected. In addition, a “-” mark in FIG. 4B indicates that an item has not been selected as a display position. The contents of the display position memory M4 are arbitrarily set by a user operation for each electronic paper 3 based on the size, shape, and the like of the electronic paper 3. In the shown example, two items, that is, “on electronic paper” and “near electronic paper” have been shown as display positions. However, the present invention is not limited thereto. For example, “right side on electronic paper”, “near right-lateral side of electronic paper”, and the like may be added as selectable items.

Next, the operation concept of the information output control device (camera-equipped projector device) 1 in the first embodiment is described with reference to the flowcharts depicted in FIG. 5 to FIG. 7. Here, each function described in the flowcharts is stored in a readable program code format, and operations based on these program codes are sequentially performed. Also, operations based on the above-described program codes transmitted over a transmission medium such as a network can also be sequentially performed. That is, the unique operations of the present embodiment can be performed using programs and data supplied from an outside source over a transmission medium, in addition to a recording medium.

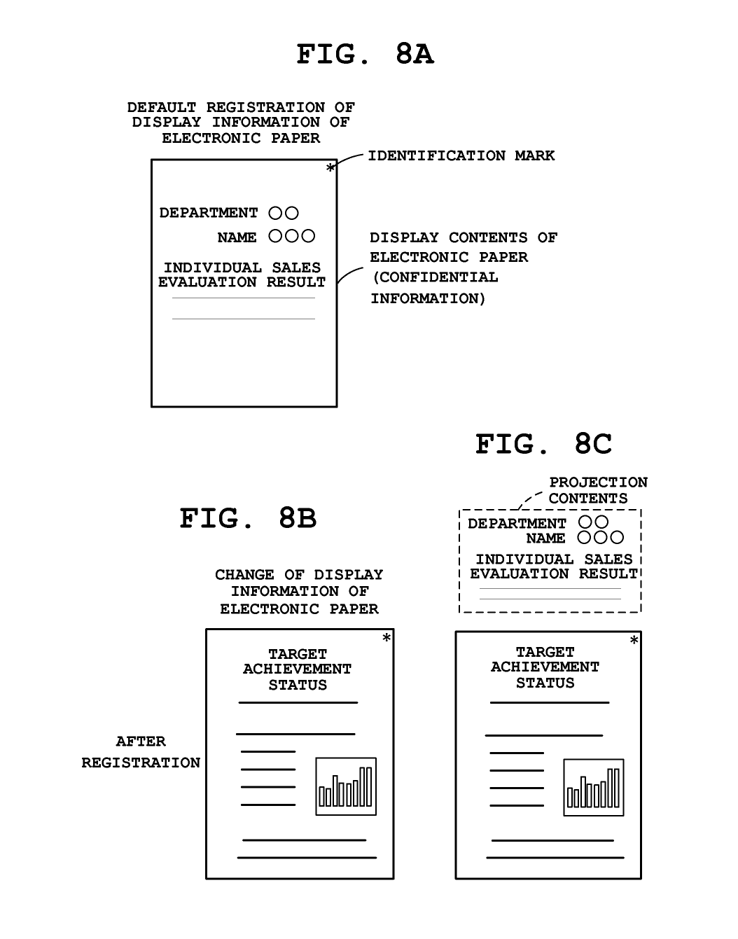

FIG. 5 to FIG. 7 depict a flowchart for describing an operation (characteristic operation of the present embodiment) of the projector device 1 which is started upon power up. In the following descriptions, the characteristic operation of the present embodiment is specifically described with reference to FIG. 3 and FIG. 8A to FIG. 8C.

First, the CPU 11 of the projector device 1 activates the camera section 16 upon power up, starts image capturing of the projectable area 2a, and sequentially captures images (Step S1 of FIG. 5). Then, while sequentially acquiring captured images of the projectable area 2a and performing image analysis (Step S2), the CPU 11 judges whether predetermined electronic paper 3 has been placed in the projectable area 2a (Step S3) and whether predetermined electronic paper 3 has been moved away from the projectable area 2a (Step S4).

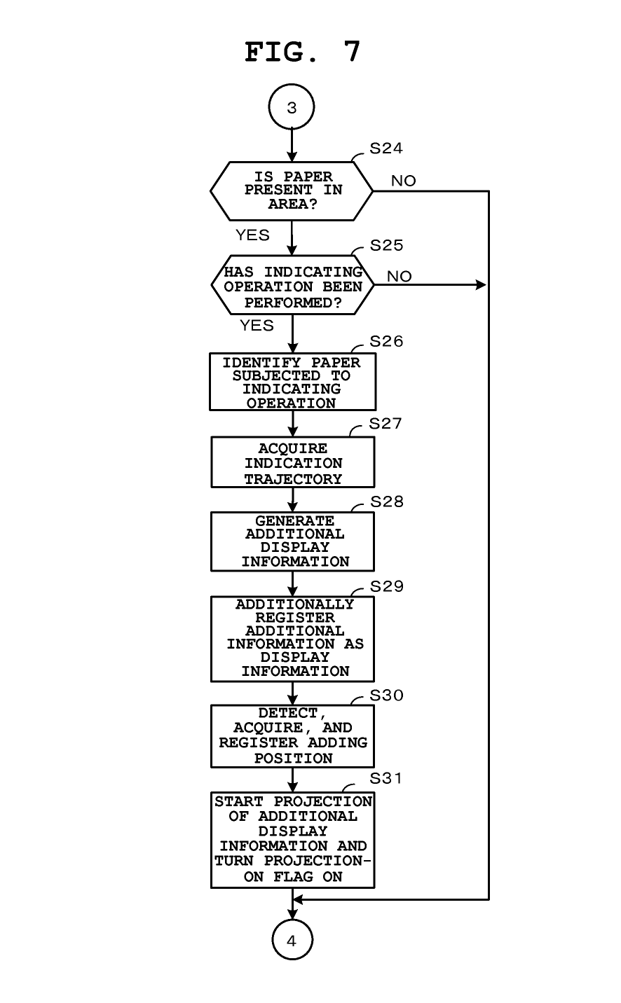

That is, the CPU 11 judges whether electronic paper 3 (electronic paper 3 with the identification mark 3a) has entered (has been placed) or exited (moved away from) the projectable area 2a. Here, the CPU 11 detects entering or exiting timing while comparing a plurality of sequentially captured images (Step S3 and Step S4). When the entering or exiting of electronic paper 3 is not detected (NO at Step S3 and Step S4), the CPU 11 proceeds to the flow of FIG. 7 and judges whether predetermined electronic paper 3 (electronic paper 3 with the identification mark 3a) is present in the projectable area 2a (Step S24). When judged that the predetermined electronic paper 3 is not present (NO at Step S24), the CPU 11 returns to Step S2 of FIG. 5. When judged that the predetermined electronic paper 3 is present (YES at Step S24), the CPU 11 judges whether an indicating operation such as that depicted in FIG. 3D has been performed (Step S25). Here, the CPU 11 analyzes captured images to judge whether they include a finger or a pen that is present on the predetermined electronic paper 3 or at a position nearby. Then, when the images do not include a finger or a pen, the CPU 11 judges that an indicating operation has not been performed (NO at Step S25), and returns to Step S2 of FIG. 5.

At Step S3, when the predetermined electronic paper 3 is detected to have been placed in the projectable area 2a (YES at Step S3), the CPU 11 specifies the electronic paper 3 in captured images of the projectable area 2a, extracts an image of this portion (paper image) (Step S5), and judges whether display information is present (included) in the paper image (Step S6). Here, when the electronic paper 3 itself is displaying information as depicted in FIG. 3A (YES at Step S6), since display information is present (included) in the paper image, the CPU 11 searches the display information memory M3 based on the paper image and judges whether registration has been made, that is, judges whether the identification mark 3a added to the specified electronic paper (specified paper) 3 has been stored in “identification mark” of “paper identification information” in the display information memory M3 (Step S7).

When the specified paper 3 has not been registered (NO at Step S7), that is, when unregistered electronic paper 3 has been placed in the projectable area 2a, the CPU 11 proceeds to processing for newly registering this electronic paper 3. Here, the CPU 11 first generates new “identification mark” of “paper identification information” based on the unregistered paper image (Step S8), and also generates its “ID” (Step S9). In this case, the CPU 11 extracts the identification mark from the paper image and generates the extracted image as “identification mark”. In addition, the CPU 11 updates a serial number to generate “ID” and newly registers these generated “identification mark” and “ID” on “paper identification information” in the display information memory M3 (Step S10). Moreover, the CPU 11 extracts the display information from the paper image, generates default information (Step S11), and newly registers the generated default information in “display information (default information)” on the display information memory M3 (Step S12). Then, the CPU 11 returns to the above-described Step S2.

After the electronic paper 3 is newly registered as described above, when the electronic paper 3 is moved away from the projectable area 2a (YES at Step S4), the CPU 11 proceeds to the next Step S13 and judges whether the “projection-ON flag” of this paper has been turned ON. At this point, the “projection-ON flag” has not been turned ON (NO at Step S13), and therefore the CPU 11 returns to the above-described Step S2.

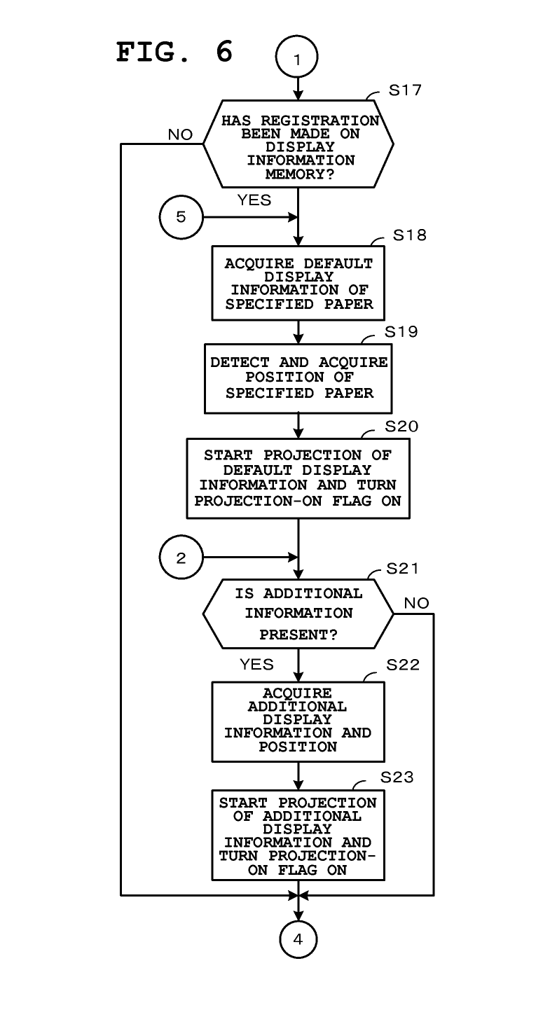

Here, when the display information on the electronic paper 3 is totally deleted and the electronic paper 3 displaying no information is placed again in the projectable area 2a as depicted in FIG. 3B (YES at Step S3), the CPU 11 judges at Step S6 that no display information is included in the electronic paper 3. Accordingly, the CPU 11 proceeds to the flow of FIG. 6 and judges whether the electronic paper 3 has been registered, with reference to the display information memory M3 (Step S17). Here, when judged that the electronic paper 3 has not been registered (NO at Step S17), the CPU 11 returns to Step S2 of FIG. 5 to remove this electronic paper 3 from projection targets. Conversely, when judged that the electronic paper has been registered (YES at Step S17), the CPU 11 reads out “display information (default information)” corresponding to this electronic paper 3 from the display information memory M3 (Step S18).

Next, the CPU 11 detects and acquires the position of the electronic paper (Step S19). That is, the CPU 11 detects and acquires the position where the electronic paper (specified paper) 3 is present (position in a plane coordinate system), with a reference point (for example, an upper-left corner) in the projectable area 2a as a starting point. Then, the CPU 11 starts an operation for projecting and displaying the acquired “display information (default information)” at the detected position, and turns the “projection-ON flag” on (Step S20). In this case, the CPU 11 determines a display position of the specified paper 3 with reference to the display position memory M4, and causes “display information (default information)” to be projected and displayed at this position. In the example of FIG. 3C, “display information (default information)” has been projected and displayed on the specified paper 3. Next, the CPU 11 judges whether “display information (additional information)” has been registered for the specified paper 3 (Step S21). When judged that no additional information has been registered (NO at Step S21), the CPU 11 returns to Step S2 of FIG. 5.

When “display information (default information)” is being projected and displayed on the electronic paper 3 as described above, if an indicating operation such as that depicted in FIG. 3D is performed, the CPU 11 detects at Step S25 of FIG. 7 that an indicating operation has been performed, and therefore proceeds to the next Step S26 to identify for which electronic paper 3 the indicating operation has been performed. Subsequently, the CPU 11 acquires an indication trajectory from captured images (a plurality of sequentially captured images) of the projectable area 2a (Step S27), generates additional display information based on this indication trajectory (Step S28), and additionally registers the additional display information in “display information (additional information)” on the display information memory M3 (Step S29). Then, the CPU 11 detects and acquires an adding position, and registers the acquired adding position in “adding position” on the display information memory M3 (Step S30).

Next, the CPU 11 starts an operation of projecting and displaying “display information (additional information)” in association with the electronic paper (specified paper) 3, and turns the “projection-ON flag” on (Step S31). In this case as well, the CPU 11 determines a display position with reference to the display position memory M4, and causes “display information (additional information)” to be projected and displayed at this position (refer to FIG. 3D). Then, the CPU 11 returns to Step S2 of FIG. 5. Here, when the specified paper 3 is moved away from the projectable area 2a, the CPU 11 detects this movement at Step S4 of FIG. 5, and then proceeds to Step S13. However, in this case, the “projection-ON flag” has been turned on (YES at Step S13). Therefore, the CPU 11 proceeds to the next Step S14 to end the projection display. As a result, the projection display is deleted, and therefore the display of the electronic paper 3 is changed from the display state of FIG. 3C to the display state of FIG. 3B. Then, after turning the “projection-ON flag” off (Step S15), the CPU 11 returns to Step S2.

After the above-described additional registration, when the electronic paper 3 which is not displaying any information is placed again in the projectable area 2a as depicted in FIG. 3E (YES at Step S3 and NO at Step S6 in FIG. 5), the CPU 11 proceeds to the flow of FIG. 6 and performs processing for reading out “display information (default information)” corresponding to the specified paper 3 from the display information memory M3 for projection display (Step S18 to Step S20) on condition that the specified paper 3 has been registered on the display information memory M3 (YES at Step S17). Then, the CPU 11 judges whether additional information has been registered (Step S21). Here, since “display information (additional information)” has been registered corresponding to the specified paper 3 (YES at Step S21), the CPU 11 reads out “display information (additional information)” and “adding position” from the display information memory M3 (Step S22), starts an operation of projecting and displaying the additional information at this adding position, and turns the “projection-ON flag” on (Step S23).

As a result “display information (default information)” and “display information (additional information)” are projected and displayed in association with the specified paper 3 as depicted in FIG. 3F. In this case as well, the CPU 11 determines a display position of the specified paper 3 with reference to the display position memory M4, and causes “display information (default information)” and “display information (additional information)” to be projected and displayed at this position (refer to FIG. 3F). Then, the CPU 11 returns to Step S2 of FIG. 5. When another indicating operation is performed in the display state of FIG. 3F, the CPU 11 performs Step S24 to Step S31 of FIG. 7. As a result, the contents of the projection display include the newly-added information, as depicted in FIG. 3G. Here, when the specified paper 3 is moved away from the projectable area 2a, the CPU 11 detects this movement at Step S4 of FIG. 5, and deletes the projection display (Step S14). As a result, the display state is returned from that of FIG. 3G to that of FIG. 3E.

FIG. 8A to FIG. 8C are diagrams for describing projection contents displayed in association with the electronic paper 3 in the projectable area 2a when “near electronic paper” is selected as a display position for projection display.

FIG. 8A shows a state where the electronic paper 3 itself is displaying confidential information as display information. That is, on the electronic paper 3, the department and name of a sales person is being displayed, and also the sales person's sales evaluation result is being displayed as confidential information. When the electronic paper 3 is placed in the projectable area 2a on the desk surface 2, the projector device 1 extracts display information of the electronic paper 3 from an image captured by its camera and registers the extracted display information as default information.

FIG. 8B shows a state where the electronic paper 3 displaying specific information regarding a target achievement status used as a reference for sales evaluation in place of confidential information such as that depicted in FIG. 8A (department, name, and evaluation result) has been placed again in the projectable area 2a on the desk surface 2. In this case, when the electronic paper 3 is placed in the projectable area 2a on the desk surface 2 (YES at Step S3 of FIG. 5), the CPU 11 detects that information is being displayed on the specified paper 3 (YES at Step S6). Therefore, the CPU 11 proceeds to the next Step S7 and judges whether the specified paper 3 has been registered on the display information memory M3. In the example of FIG. 8B, the specified paper 3 has been registered (YES at Step S7), and therefore the CPU 11 judges whether “near electronic paper” has been selected as a display position of the specified paper 3, with reference to the display position memory M4 (Step S16).

When judged that “near electronic paper” has been selected as a display position of the specified paper 3 (YES at Step S16), the CPU 11 proceeds to Step S18 to Step S20 of FIG. 6 and performs processing for reading out “display information (default information)” corresponding to the specified paper 3 from the display information memory M3, and projecting and displaying it in an area near the specified paper 3. FIG. 8C shows a state in which the confidential information (department, name, and evaluation result) depicted in FIG. 8A is being projected and displayed near the specified paper 3 (near an upper portion thereof), and also the target achievement status, evaluation target, and evaluation result are being displayed. When the specified paper 3 is moved away from the projectable area 2a after the user confirms the projected contents (confidential information), the CPU 11 detects this movement at Step S4 of FIG. 5, and then proceeds to Step S13 to delete the projection display on condition that the projection-ON flag is on (Step S14). Accordingly, the display state of FIG. 8A is returned to that of FIG. 8B.

As described above, when “near electronic paper” has been selected as a display position of the specified paper 3 (YES at Step S16), the CPU 11 performs processing for reading out “display information (default information)” corresponding to the specified paper 3, and projecting and displaying it in an area near the specified paper 3 (Step S18 to S20 of FIG. 6). However, when “on electronic paper” has been selected (NO at Step S16), the CPU 11 proceeds to Step S21 and performs processing for causing additional information to be projected and displayed on the specified paper 3 on condition that the additional information is present (Step S22 and Step S23).

As described above, the information output control device (projector device) 1 in the first embodiment includes the display information memory M3 that stores display information in association with a display target (electronic paper 3) that is present outside. When the display target that is present in a predetermined area is recognized and identified, display information associated with this display target is read out from the display information memory M3, and the position of the display target in the predetermined area is acquired. Then, the output of the acquired display information is controlled such that the display information is displayed in association with the display target that is present at the acquired position. As a result of this configuration, the output of display information can be appropriately controlled based on to which display target the display is directed and in which area the display target is present.

Accordingly, information with high confidentiality, which is normally not displayed, can be displayed in association with a display target only during a period in which the display target is present in a predetermined area. That is, the present embodiment can be utilized for security management of information with high confidentiality such as personal information. Also, real-time information such as stock prices and sales status can be displayed in association with a display target.

Also, the CPU 11 of the projector device 1 ends the output of display information when a display target is judged as not being present in a predetermined area. As a result of this configuration, display information can be outputted on condition that a display target is present in a predetermined area.

Moreover, the CPU 11 detects an indicating operation on a display target, generates information in accordance with an indication trajectory as display information, and causes the display information to be stored in the display information memory M3 in association with the display target. As a result of this configuration, information arbitrarily added in accordance with an indicating operation can also be displayed, which can be used when a checked part is confirmed or can be used as a memorandum.

Furthermore, the CPU 11 extracts display information from an image of display information displayed on a display target and stores the display information in the display information memory M3 in association with the display target. As a result of this configuration, even if display information is deleted from a display target, this display information can be reproduced only by the display target being placed again in a predetermined area.

Still further, in order to cause display information to be displayed in association with a display target, the display position memory M4 stores information indicating a display position in association with the display target, and the display information is outputted such that the display information is displayed at the display position of the specified paper 3, with reference to the display position memory M4. As a result of this configuration, display information can be displayed at an appropriate position for each specified paper 3.

Yet still further, in order to cause display information to be displayed in association with a display target, a position on the display target or a position near the display target is set as a display position, which can be arbitrarily set by a user operation. As a result of this configuration, display position can be changed as appropriate for each display target.

Yet still further, from a captured image of a display target which is present in a predetermined area, identification information of the display target is identified, and display information associated with the identification information is read out and acquired from the display information memory M3. As a result of this configuration, the correspondence between a display target and display information is clarified, and display information can be read out for each display target from the display information memory M3.

In the above-described first embodiment, when information is being displayed on the specified paper at Step S6 of FIG. 5 (YES at Step S6) and “on electronic paper” has been selected as a display position (NO at Step S16), if additional information is present (YES at Step S21 of FIG. 6), this additional information is projected and displayed on the specified paper (Step S22 and Step S23). However, a configuration may be adopted in which default information is projected and displayed on the specified paper under a predetermined condition. For example, on condition that a blank portion is present on the specified paper, default information may be projected and displayed on this blank portion.

Also, in the above-described first embodiment, an image acquired by extracting the identification mark (for example, an asterisk mark) 3a printed at the corner of the electronic paper 3 is taken as “identification mark” of “paper identification information”. However, “paper identification information” is not limited thereto, and may be the shape or contour of the electronic paper 3. Also, a configuration may be adopted in which a display target has a wireless communication function, and the projector device 1 identifies each display target by receiving identification information sent from the display target. In addition, a configuration may be adopted in which, by analyzing a captured image and thereby detecting the shape or contour of a display target, the display target and another object such as a portable terminal device can be distinguished.

Moreover, in the above-described first embodiment, the identification mark 3a is provided to identify the plurality of pieces of electronic paper 3, and taken as a key for identification. However, a configuration may be adopted in which display contents displayed on a single piece of electronic paper 3 is taken as a key for identification. For example, in a case where electronic paper displays a magazine or the like by switching the pages, a captured image of each page may be analyzed, and display contents of the page may be extracted and registered as a key for identification.

Furthermore, in the above-described first embodiment, display information (default information) is displayed. However, a configuration may be adopted in which only the addition of information inputted by handwriting is performed. In this configuration, in a case where electronic paper displays a magazine or the like by switching the pages, if an adding operation is performed on the electronic paper displaying the first page, display contents of the first page are taken as a key for identification, and handwritten information is stored in association with the first page. Then, when the electronic paper displaying that first page is placed again, the handwritten information stored in association with this page is read out as a key for identification, and added to this page. Then, the same procedure is performed for the second page and the following pages. That is, handwritten information is added for each page every time the pages are switched and displayed, with the display contents of each page as a key for page identification.

Still further, in the above-described first embodiment, the electronic paper 3 has been shown as an example of the display target. However, the display target may be another display device such as a touch screen, a liquid-crystal panel, or an organic EL (Electro Luminescence) display, or a simple object such as a magazine, a notebook, an ornament, or a paper piece. In this case, an image may be projected and displayed on the object by projection mapping.

Yet still further, in the above-described first embodiment, a motion of a finger or a pen is imaged by the camera section 16 at the time of addition, the captured image is analyzed, and additional display information is generated from its indication trajectory and registered on the display information memory M3. However, the present embodiment is not limited to the case where additional information is inputted by a motion of a finger or a pen. For example, a configuration may be adopted in which information arbitrarily handwritten by an electronic pen of an electromagnetic induction type on the electronic paper 3 supplied with power is imaged and captured by the camera section 16, and the captured image is analyzed and registered on the display information memory M3 as additional information. Note that, even if information is written in the electronic paper 3 with an electronic pen of an electromagnetic induction type as described above, handwritten information (additional information) is deleted thereafter from the electronic paper 3. Even if the handwritten information (additional information) is deleted from the electronic paper 3 as described above, the handwritten information (additional information) is projected and displayed (reproduced) on the electronic paper 3 when the electronic paper 3 is placed again in the predetermined area (projectable area 2a).

Yet still further, in the above-described first embodiment, handwritten information is imaged and captured by the camera section 16, and the captured image is analyzed and registered on the display information memory M3 as additional information. However, if the display target is a communication device having a short-distance wireless communication function, the handwritten information may be received via wireless communication with the display target and registered on the display information memory M3 as additional information. In this case, device identification information (ID) is received and acquired at the time of communication with the communication device.

Yet still further, in the above-described first embodiment, when the electronic paper 3 is placed again in the predetermined area (projectable area 2a) after information in the electronic paper 3 is registered as default information, images captured by the camera section 16 are analyzed, and the position of the electronic paper 3 is detected. However, the detection of the position of the electronic paper 3 is not limited thereto. For example, a configuration may be adopted in which a large touch panel sheet is spread over the projectable area 2a on the desk surface 2, and the position of the electronic paper 3 is detected based on a touch position when the electronic paper is placed on the touch panel sheet. Alternatively, a configuration may be adopted in which a plurality of (for example, three or four) short-distance communicating sections (for example, Bluetooth (registered trademark) communicating sections or RF tag communicating sections) are arranged at predetermined positions on a desk and, when electric waves sent from a display target are received at the respective communicating sections, the information output control device (projector device) 1 acquires a reception signal from each of the communicating sections and detects the position of the display target by the calculation of radio field intensity and based on the principles of triangulation.

Yet still further, in the above-described first embodiment, the present invention has been applied in a projector device as an information output control device. However, the present embodiment is not limited thereto. For example, the present invention may be applied in a camera-equipped PC (Personal Computer), a PDA (Personal Digital Assistant), a tablet terminal device, a portable telephone such as a smartphone, an electronic game machine, or a communication function equipped PC.

Yet still further, in the above-described first embodiment, the electronic paper 3 is placed in the projectable area 2a on the desk surface 2. However, the electronic paper 3 may be placed (set) on a wall surface or floor surface of a room. Also, the present embodiment is effective not only for meetings but also for counter service where references are presented. Also, a paper reference (analog information) including a printed matter such as a pamphlet and a handwriting memo and digital information of the electronic paper 3 may be combined together.

### Second Embodiment

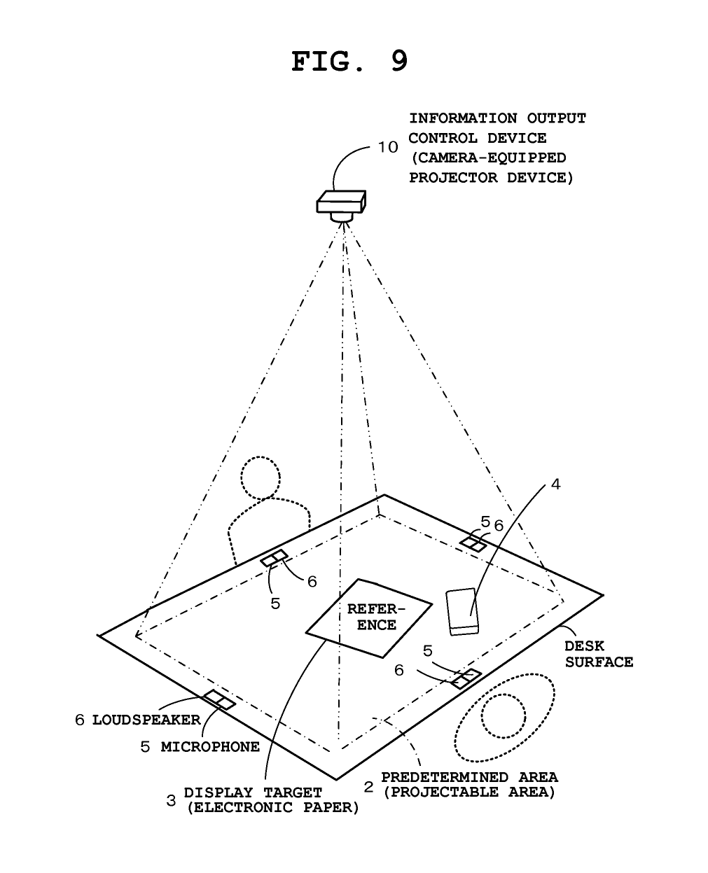

Next, a second embodiment of the present invention is described with reference to FIG. 9 to FIG. 14.

In the second embodiment, the present invention has been applied in a camera-equipped projector device as an information output control device which outputs display information. FIG. 9 is a diagram showing an example of use of this camera-function-equipped projector device.

An information output control device (camera-equipped projector device) 10 in FIG. 9 has a projector function, a camera function, a communication function, and the like. For example, when a counter service worker in a financial institution or the like is facing a customer for over-the-counter service with a reference being presented on a desk surface or when meeting attendees are conducting a discussion with a reference being presented on a desk surface, the projector device 10 images an entire desk surface and performs projection display. The information output control device 10 is fixedly arranged onto a ceiling surface, wall surface, or the like of a room.

That is, the camera-equipped projector device 10 applies light in accordance with display information to an output target (electronic paper 3) on a desk surface from above for projection display, and captures an image of an entire desk surface. In the shown example, the electronic paper 3 serving as a reference and another object (for example, a portable terminal device 4) have been placed in a predetermined area (projectable area) 2 on a desk surface in counter service. By analyzing an image acquired by the predetermined area (projectable area) 2 on the desk surface being captured, the projector device 10 distinguishes between the electronic paper 3 and the other object.

The electronic paper 3 is an output target when unique display information is displayed in association therewith, that is, an output target that is present outside the projector device 10. Information displayed on the electronic paper 3 serves as a reference in the counter service. For example, confidential information such as personal information or real-time information such as stock prices or sales status is projected and displayed from the projector device 10 onto the electronic paper 3. That is, as will be described later in detail, when the projector device 10 is placed in the predetermined area (projectable area) 2 on the desk surface, the projector device 10 controls the output of the display information stored in advance in association with the electronic paper 3 such that the display information is displayed in the projectable area 2 in association with the electronic paper 3. When the electronic paper 3 is moved away from the projectable area 2, the projector device 10 performs control such that the projection display of the display information is deleted.

The electronic paper 3 is constituted by, for example, microcapsule-type electronic paper (electrophoretic display) using an electrophoretic phenomenon, and has many media filled with colored charged particles (charged objects) arranged between paired facing electrodes. When voltage is applied between the paired electrodes, the charged particles within this media move in a direction corresponding to the applied voltage, whereby display is performed. Also, a highly-directive microphone 5 and a loudspeaker 6 are arranged at each of the peripheral edges (four edges) of the rectangular desk surface.

The projectable area 2 on the desk surface is an area that can be imaged. When the electronic paper 3 is recognized to be present in the projectable area 2 by captured images of the projectable area 2 being analyzed, the projector device 10 starts an operation of projecting and displaying display information unique to the paper in association with the electronic paper 3. This projector device 10 has a function for adjusting, when the position of the electronic paper 3 is identified from captured images of the projectable area 2, a projecting direction (applying direction) to the direction of this position.

That is, the projector device 10 has a projecting direction adjusting function (omitted in the drawing) by which a projecting direction can be freely adjusted within the range of the projectable area 2 by an optical system being driven in accordance with the presence position of the electronic paper 3. Also, when a projection operation is started for the electronic paper 3 in the projectable area 2, the projector device 10 monitors whether the electronic paper 3 has been moved away from the projectable area 2 to be outside of this area, while analyzing captured images of the projectable area 2. Then, when the electronic paper 3 is detected to have been moved away from the projectable area 2 as described above, the projector device 10 stops the projection operation on the electronic paper 3 (deletes projection display).

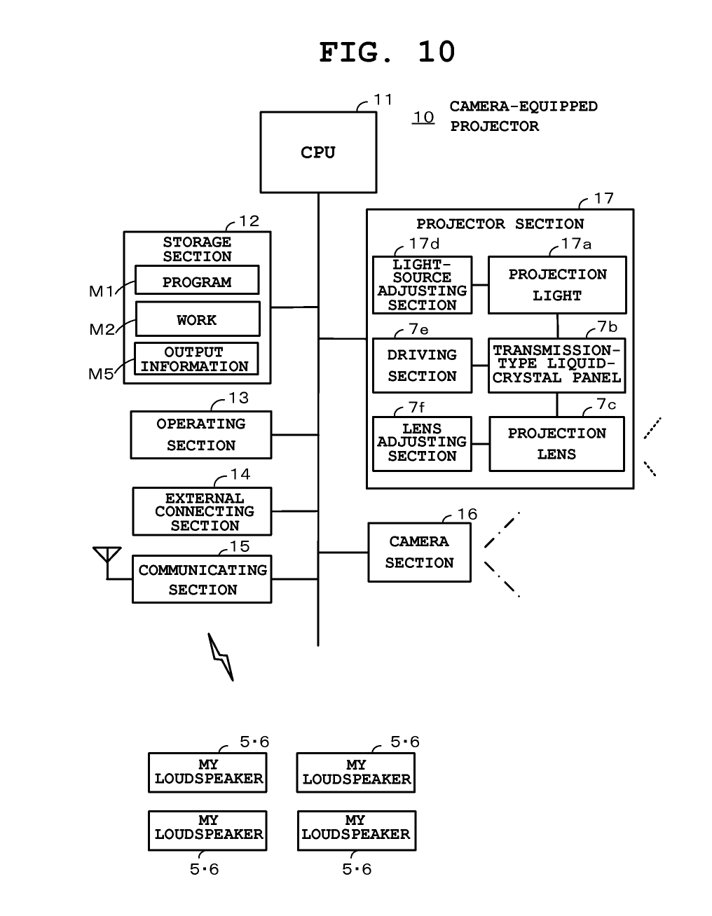

FIG. 10 is a block diagram showing basic components of the information output control device (camera-equipped projector device) 10.

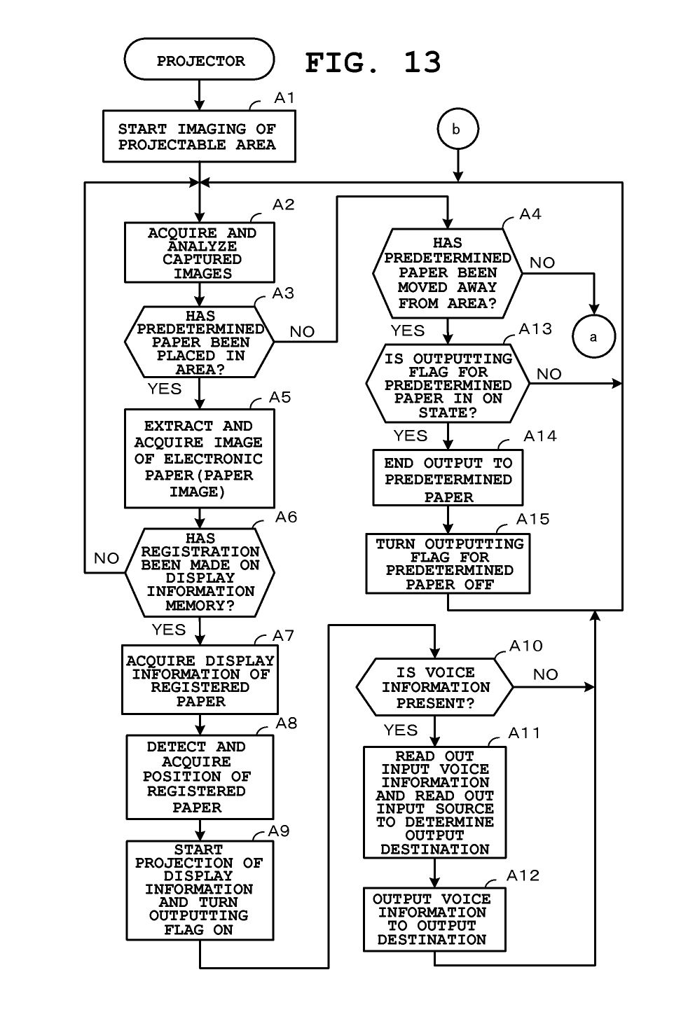

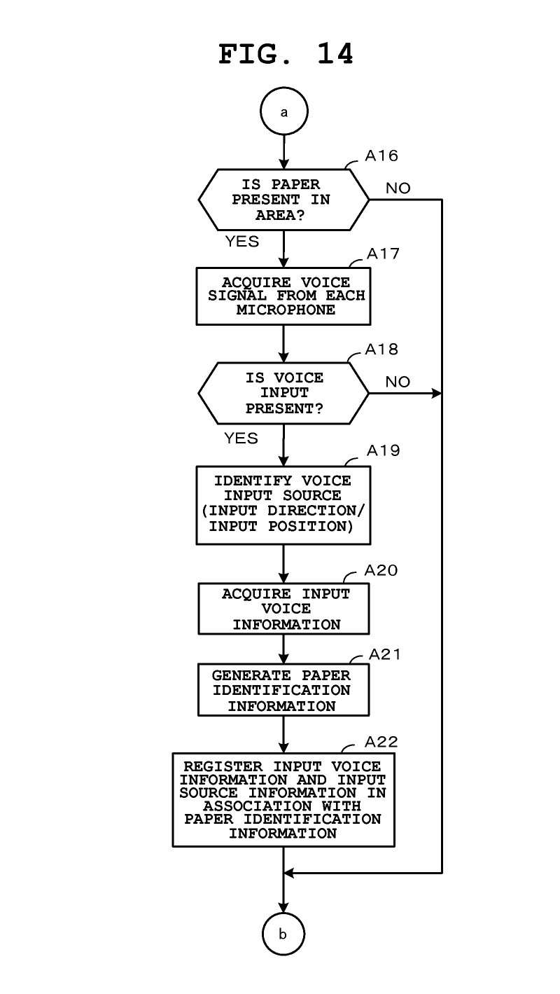

The projector device 10 has a CPU 11 as a main component. This CPU 11 is a central processing unit that controls the entire operation of the projector device 10 by following various programs in a storage section 12. The storage section 12 is constituted by, for example, a ROM, a flash memory, and the like, and has a program memory M1 that stores a program for achieving the present embodiment in accordance with an operation procedure depicted in FIG. 13 and FIG. 14, a work memory M2 that temporarily stores various data (such as clock time, timer measurement time, and flag) required in the projector device 10, an output information memory M5 described later, and the like. Note that the storage section 12 may be structured to include a detachable portable memory (recording media) such as an SD card or an IC card. Although not depicted, in a case where the storage section 12 is connected to a network by a communication function, the storage section 12 may include a storage area on the side of a predetermined server apparatus.

The CPU 11 has an operating section 13, an external connecting section 14, a communicating section 15, a camera section 16, a projector section 17, and the like connected thereto as input/output devices. This CPU 11 controls each of the input/output devices by following an input/output program. The operating section 13 has a power supply button, a projection adjustment button, and the like. The external connecting section 14 is a connector section to which an external device (omitted in the drawing) such as a personal computer (PC) and a recording medium is connected. The communicating section 15 is a communication interface connected for communication with an external device by, for example, wireless LAN (Local Area Network) or Bluetooth (registered trademark) communication, and performs the transmission and reception of voice information to and from the above-described microphones 5 and loudspeakers 6.

The camera section 16 constitutes the above-described imaging function, and has a lens mirror block including an imaging lens and a mirror, an image-pickup element, and its driving system, as well as a distance-measuring sensor, a light-amount sensor, an analog processing circuit, a signal processing circuit, a compression/decompression circuit, and the like omitted in the drawing. Also, the camera section 16 has an autofocus function for automatic focusing, a zoom function for controlling an imaging range, and the like. The projector section 17 constitutes the above-described projector function, and includes a projection light 17a for lighting up when power supply is received, a transmission-type liquid-crystal panel 17b where an image of a projection target is displayed, a projection lens 17c, a light-source adjusting section 17d which controls the projection light 17a to be turned on or off and controls the luminance thereof, a driving section 17e which drives the transmission-type liquid-crystal panel 17b, and a lens adjusting section 17f which adjusts the focus, zoom, and the like of the projection lens 17c. The optical axis direction of the imaging lens of the camera section 16 coincides with the optical axis direction of the projection lens 17c, whereby the above-described projectable area 2 can be imaged.

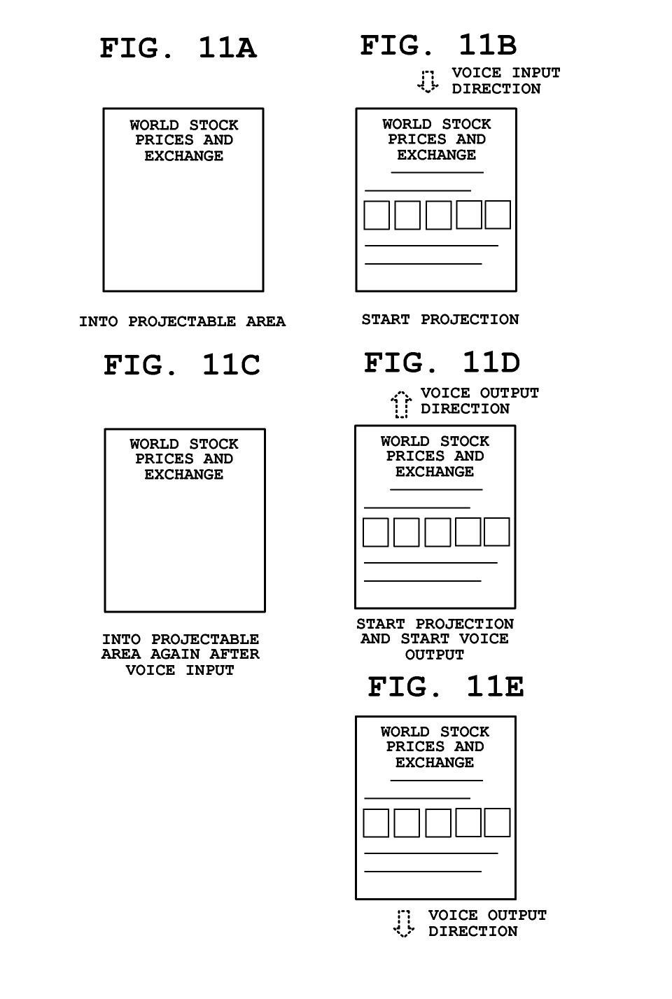

FIG. 11A to FIG. 11E are diagrams for describing projection contents and voice input/output status displayed in association with the electronic paper 3 placed in the projectable area 2.

When an output target (electronic paper 3) is placed in the predetermined area (projectable area 2), the projector device 10 of the second embodiment reads out display information associated with the electronic paper 3 from the output information memory M5 for projection display. Subsequently, when arbitrary voice information is inputted while the electronic paper 3 is present in the projectable area 2, the projector device 10 registers the input voice information on the output information memory M5 in association with the electronic paper 3. Then, when the electronic paper 3 is placed again later on in the projectable area 2, the projector device 10 reads out the voice information corresponding to the electronic paper 3 from the output information memory M5, and performs reproduction output.

FIG. 11A is a diagram depicting information fixedly displayed by the electronic paper 3 itself as the title “World Stock Prices and Exchange”. When the electronic paper 3 is placed in the projectable area 2 on the desk surface, the projector device 10 reads out display information stored corresponding to the electronic paper 3 and causes the read display information to be projected and displayed on the electronic paper 3 in the projectable area 2. FIG. 11B shows a state in which detailed main body information is projected and displayed on the electronic paper 3 subsequently to the title “World Stock Prices and Exchange”.

The CPU 11 receives input voice collected by the highly-directive microphones 5 while the electronic paper 3 is present in the projectable area 2, and records voice information together with identification information of the electronic paper 3 on the output information memory M5. Here, the CPU 11 determines a direction or a position from which voice has been inputted, with reference to the orientation of the electronic paper 3 (for example, oriented to front) in the projectable area 2. Subsequently, the CPU 11 takes the voice input direction or position as information indicating the voice input source, and stores this information together with the inputted voice information in the output information memory M5. Then, when the electronic paper 3 is placed again later on in the projectable area 2, the CPU 11 determines the output destination of the voice information stored in the output information memory M5, based on the information indicating the input source stored in association with the electronic paper 3, and voice output is performed from the highly-directive loudspeaker 6 arranged in the direction of the output destination or at the position thereof. Note that, although voice information generally refers to information of voice emitted by a human through the speech organ, it refers to a general term of sound emitted from a human in the second embodiment.

FIG. 11C is a diagram showing a case where the electronic paper 3 is placed again in the projectable area 2 after voice is inputted as described above. When the electronic paper 3 is placed again in the projectable area 2, the projector device 1 recognizes the electronic paper 3 and reads out its display information from the output information memory M5 for projection display. Also, the projector device 1 reads out voice information, determines the output destination of the voice information, and produces voice output of the voice information from the loudspeaker 6 serving as the output destination. FIG. 11D shows a case where a direction or a position identical to the input direction or the position of voice depicted in FIG. 11B is determined as an output destination, and FIG. 11E shows a case where a direction or a position opposite to the input direction or the position of voice depicted in FIG. 11B is determined as an output destination.

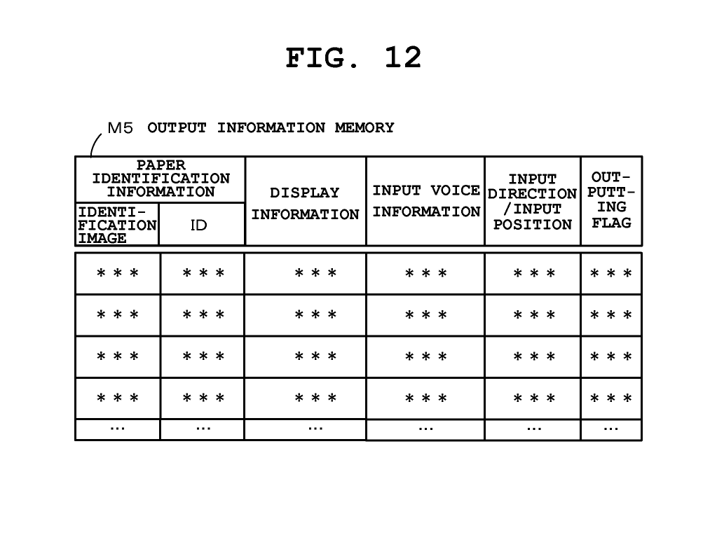

FIG. 12 is a diagram for describing the output information memory M5.

The output information memory M5, which stores and manages display information and input voice information in association with a plurality of output targets (electronic paper 3), has items of “paper identification information”, “display information”, “input voice information”, “input direction/input position”, and “outputting flag”. “Paper identification information” is information for identifying each electronic paper 3 and includes items of “identification image” and “ID”. “Identification image” is an image acquired by extracting the electronic paper 3 from a captured image of the projectable area 2. For example, a display content such as a title name displayed on the electronic paper 3 is taken as identification information. “ID” is a numerical value string data (for example, a serial number) generated for identifying each electronic paper 3.

“Display information” indicates display information stored in advance in association with the electronic paper 3. For example, main body information indicating details corresponding to the electronic paper 3 where “World Stock Prices and Exchange” is being displayed as a title serves as “display information”. “Input voice information” indicates voice information inputted and recorded while the electronic paper 3 is present in the projectable area 2. “Input direction/input position” indicates an input source of an inputted voice. In the example of FIG. 9, the microphones 5 and the loudspeakers 6 arranged on the four edges of the desk surface are classified into four directions/positions (upper, lower, left and right), and one of these upper, lower, left, and right directions/positions is stored as an input source. “Outputting flag” is a flag indicating that projection display is being performed in association with the electronic paper 3.

Next, the operation concept of the information output control device (camera-equipped projector device) 1 in the second embodiment is described with reference to the flowcharts depicted in FIG. 13 and FIG. 14. Here, each function described in the flowcharts is stored in a readable program code format, and operations based on these program codes are sequentially performed. Also, operations based on the above-described program codes transmitted over a transmission medium such as a network can also be sequentially performed. That is, the unique operations of the present embodiment can be performed using programs and data supplied from an outside source over a transmission medium, in addition to a recording medium. This applies to another embodiment described later.

FIG. 13 and FIG. 14 depict a flowchart for describing an operation (characteristic operation of the second embodiment) of the projector device 10 which is started upon power up. In the following descriptions, the characteristic operation of the second embodiment is specifically described with reference to FIG. 11A to FIG. 11E.

First, the CPU 11 of the projector device 10 activates the camera section 16 upon power up, starts image capturing of the projectable area 2 on the desk surface, and sequentially captures images (Step A1 of FIG. 13). Then, while sequentially acquiring captured images of the projectable area 2 and performing image analysis (Step A2), the CPU 11 judges whether electronic paper 3 has been placed in the projectable area 2 (Step A3) and whether electronic paper 3 has been moved away from the projectable area 2 (Step A4).

That is, the CPU 11 judges whether electronic paper 3 has entered or exited the projectable area 2 by the image recognition of the shape or size of the electronic paper 3, an identification added to the electronic paper 3, or the like. Here, the CPU 11 detects entering or exiting timing while comparing a plurality of sequentially captured images (Steps A3 and A4). When the entering or exiting of electronic paper 3 is not detected (NO at Step A3 and Step A4), the CPU 11 proceeds to the flow of FIG. 14, receives an output signal from each microphone 5 (Step A17) for frequency analysis on condition that the electronic paper 3 is present in the projectable area 2 (Step A16), and judges whether voice information with a sound volume (level) equal to or larger than a predetermined sound volume (level) has been inputted from one of the microphones 5 (Step A18). When no voice information has been inputted from the microphones 5 (NO at Step A18), the CPU 11 returns to Step A2 of FIG. 13.

At Step A3, when it is detected that electronic paper 3 has been placed in the projectable area 2 as depicted in FIG. 11A (YES at Step A3), the CPU 11 extracts an image of the electronic paper 3 (paper image) from captured images of the projectable area 2 (Step A5), searches the output information memory M5 based on the paper image, and judges whether the electronic paper 3 has been registered, that is, whether the paper image has been stored in “identification image” of “paper identification information” in the output information memory M5 (Step A6). When judged that the electronic paper 3 has not been registered (NO at Step A6), the CPU 11 returns to the above-described Step A2 to disregard the unregistered electronic paper 3. When judged that the electronic paper 3 is registered electronic paper (registered paper) 2 (YES at Step A6), the CPU 11 reads out and acquires “display information” of the registered paper 3 from the output information memory M5 (Step A7), and also detects and acquires the position of the registered paper 3 (Step A8). Here, the CPU 11 detects and acquires a position where the electronic paper 3 is present (position in a plane coordinate system), with a reference point (for example, an upper-left corner) in the projectable area 2 as a starting point.

Then, the CPU 11 starts an operation of projecting and displaying the acquired “display information” at the detected position (presence position), and then turns its “outputting flag” on (Step A9). By this projection display, the display contents of the electronic paper 3 are changed from the state depicted in FIG. 11A to the state depicted in FIG. 11B. Next, the CPU 11 judges whether “input voice information” has been stored in the output information memory M5 in association with the registered paper 3 (Step A10). When judged that “input voice information” has not been stored (NO at Step A10), the CPU 11 returns to the above-described Step A2.

Here, when voice information has been inputted from one of the microphones 8 with information being projected and displayed on the electronic paper 3 present in the projectable area 2, as depicted in FIG. 11B, the CPU 11 judges at Step A18 of FIG. 14 that a voice input is present, and therefore proceeds to Step A19 to identify its voice input source based on an output signal (microphone signal) from each microphone 5 (Step A19). That is, the CPU 11 performs frequency analysis on an output signal (microphone signal) from each microphone 5, identifies a microphone 5 having the highest level (sound pressure), and identifies the arranging direction or position of this microphone 5 as a voice input direction or position (input source information), with reference to the orientation of the electronic paper 3 in the projectable area 2. Subsequently, the CPU 11 acquires inputted voice information (Step A20), and generates paper identification information with a paper image as “identification image” and a value acquired by updating the serial number as “ID” (Step A21). Next, the 11 performs processing for registering the input voice information and the input source information in association with this “paper identification information” in “input voice information” on the output information memory M5 (Step A22). Then, the CPU 11 returns to Step A2 of FIG. 13.

Then, when the electronic paper 3 is moved away from the projectable area 2 (YES at Step A4) after the voice information inputted in association with the electronic paper 3 is registered as described above, the CPU 11 proceeds to the next Step A13 and judges whether “outputting flag” of the paper is in an ON state. When “outputting flag” is not in an ON state (NO at Step A13), the CPU 11 returns to Step A2 described above. However, here, the “outputting flag” is in an ON state (YES at Step A13), and therefore the CPU 11 proceeds to the next Step A14 to ends the projection display. As a result, the projection display is deleted, and therefore the display contents of the electronic paper are changed from the display state of FIG. 11B to the display state of FIG. 11A. Then, the CPU 11 turns the “outputting flag” off (Step A15), and then returns to Step A2.

When the electronic paper 3 displaying information such as a title is placed again in the projectable area 2 as depicted in FIG. 11C (YES at Step A3) after the voice information is inputted as described above, the CPU 11 reads out “display information” corresponding to the registered paper 3 from the output information memory M5 on condition that the electronic paper 3 has been registered on the output information memory (Step A6), and projects and displays “display information” (Steps A7 to A9). Then, the CPU 11 judges whether “input voice information” has been registered in association with the registered paper 3 (Step A10). Here, since “input voice information” has been registered (YES at Step A10), the CPU 11 reads out “input voice information” and “input direction or input position” corresponding to the registered paper 3, and determines a loudspeaker 6 as an output destination based on “input direction or input position” (Step A11).

When determining a loudspeaker 6 as an output destination, the CPU 11 has three options. That is, the CPU 11 may determine a direction or position identical to the input direction or position as an output destination, may determine a direction or position opposite to the input direction or position as an output destination, or may determine a direction or position arbitrarily set by a user operation as an output destination. Here, the CPU 11 determines an output destination based on an option arbitrarily selected in advance by a user operation. FIG. 11D shows a case where a direction or position identical to the voice input direction or position depicted in FIG. 11B has been determined as an output destination, and FIG. 11E shows a case where a direction or position opposite to the voice input direction or position has been determined as an output destination. When an output destination is determined as described above, the CPU 11 causes “input voice information” to be generated and outputted from the loudspeaker 6 of the determined output destination (Step A12). Then, the CPU 11 returns to Step A2.

As described above, the input output control device (projector device) 10 in the second embodiment includes the output information memory M5 that stores information (input voice information) inputted while an output target (electronic paper 3) is in an external predetermined area (projectable area 2), in association with the electronic paper 3. When the electronic paper 3 is placed again in the projectable area 2, the input voice information stored in association with the electronic paper 3 is read out from the output information memory M5 for reproduction output. As a result of this configuration, voice information inputted in association with the electronic paper 3 and the projectable area 2 can be reproduced and outputted on condition of this association. Therefore, only by placing the electronic paper 3 in the projectable area 2, for example, it is possible to reproduce and output customer's opinions in counter service or meeting attendees' opinions.

Also, the CPU 11 of the projector device 10 ends reproduction output when the electronic paper 3 is judged as not being present in the projectable area 2. As a result of this configuration, input information can be reproduced and outputted on condition that the electronic paper 3 is present in the projectable area 2.

Moreover, the CPU 11 judges in which direction or at which position an input has been inputted, with reference to the electronic paper 3 in the projectable area 2, and stores the judgment result in the output information memory M5 as information indicating the input source, in association with the electronic paper 3. Then, when the input information is to be reproduced and outputted, the CPU 11 determines an output direction or position based on the information indicating the input source, and causes the input information to be reproduced and outputted with the determined direction or position as an output destination. As a result of this configuration, an output destination is not fixed and can be changed based on an input source.

Furthermore, when determining an output destination based on information indicating an input source, the CPU 11 determines, as an output destination, a direction or position identical to the input direction or position, a direction or position opposite to the input direction or position, or an arbitrary set direction or position. Therefore, for example, when a direction or position identical to an input direction or position is determined as an output destination, the user can easily confirm whose opinion an input represents. When a plurality of customers or attendees is present in counter service or a meeting, the user can easily confirm which customer or attendee an opinion comes from. Also, when a direction or position opposite to an input direction or position is determined as an output destination, an opinion of a facing person can be heard closely in over-the-counter service. Also, when an arbitrary direction or position set with respect to an input direction or position is determined as an output destination, opinions of a plurality of customers and attendees can be heard closely and collectively at one place.

Still further, identification information for identifying the electronic paper 3 present in the projectable area 2 is generated, and input information stored in association with the identification information is read out from the output information memory M5 for reproduction output. As a result of this configuration, the correspondence between electronic paper 3 and its input information is clarified, and input information can be reproduced and outputted for each electronic paper 3.

In the above-described second embodiment, voice information is taken as an example of input information. However, for example, handwritten information may be taken as input information. That is, a configuration may be adopted in which the motion of a finger or a pen is imaged by the camera section 16, the captured image is analyzed, and handwritten information is generated from the indication trajectory and registered on the output information memory M5. Also, the present invention is not limited to the case where handwritten information is inputted by the motion of a finger or a pen. For example, a configuration may be adopted in which information arbitrarily handwritten with an electronic pen of an electromagnetic induction type on the electronic paper 3 supplied with power is imaged by the camera section 16, and the captured image is analyzed and registered on the output information memory M5 as input information. Note that, even if information is written in the electronic paper 3 with an electronic pen of an electromagnetic induction type as described above, the handwritten information is deleted later from the electronic paper 3. Even when the handwritten information is deleted from the electronic paper 3, it is projected and displayed (reproduced and outputted) in the electronic paper 3 by the electronic paper 3 being placed again in the predetermined area (projectable area 2).

Also, a configuration may be adopted in which, in a case where electronic paper displays a magazine or the like by switching the pages, if an adding operation is performed on the electronic paper displaying the first page, display contents of the first page are taken as a key for identification, and handwritten information is stored in association with the first page. Then, when the electronic paper displaying this first page is placed again, the handwritten information stored in association with this page is read out as a key for identification, and added to this page. Then, the same procedure is performed for the second page and the following pages. That is, handwritten information is added for each page every time the pages are switched and displayed, with the display contents of each page as a key for page identification.

Moreover, in the above-described embodiment, the electronic paper 3 has been shown as an example of the output target of the present invention. However, the output target may be a display device other than electronic paper, such as a touch screen, a liquid-crystal panel, or an organic EL (Electro Luminescence) display, or a simple object such as a magazine, a notebook, an object, an ornament, or a paper piece. In this case, an image may be projected and displayed on the object by projection mapping.

### Third Embodiment

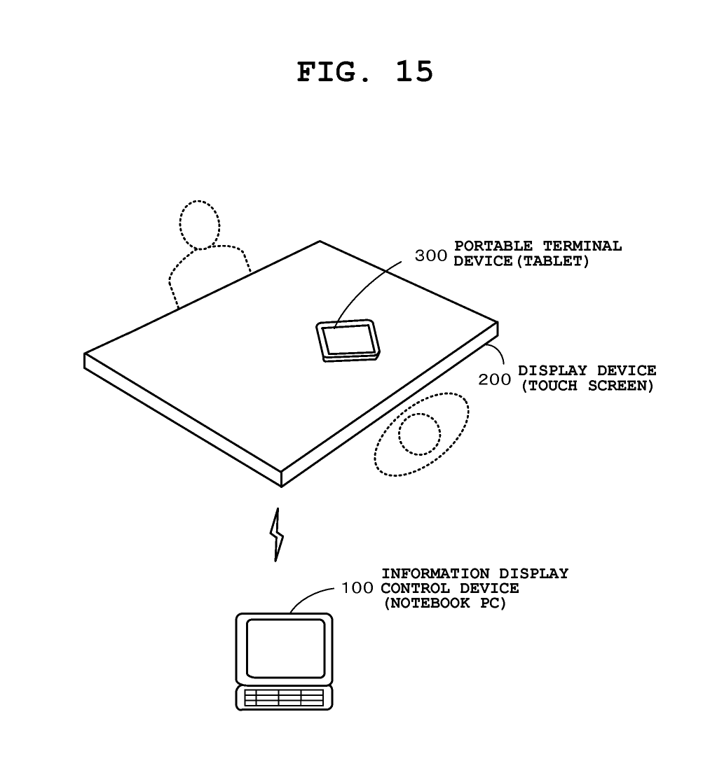

Next, a third embodiment of the present invention is described with reference to FIG. 15 to FIG. 20.

In the above-described second embodiment, the projector device 10 has been shown as an example of the information output control device of the present invention, the electronic paper 3 has been shown as an example of the output target, the projectable area 2 on the desk surface has been shown as an example of the predetermined area, and voice information has been shown as an example of the input information. However, in the third embodiment, a notebook PC (personal computer) is shown as an example of the information output control device of the present invention, electronic paper 3 is shown as an example of the output target, a display device on a desk surface is shown as an example of the predetermined area, and handwritten information is shown as an example of the input information. Note that sections that are basically the same or have the same name in both embodiments are given the same reference numerals, and therefore explanations thereof are omitted. Hereafter, the characteristic portion of the third embodiment will mainly be described.

FIG. 15 is a diagram showing an example of use of the notebook PC.

An information output control device (notebook PC) 100 in FIG. 15 is a device that is used by being connected to a display device 200 spread over a desk surface when a counter service worker is facing a customer for service with a reference being presented on the desk surface. This information output control device 100 has various basic functions as well as a communication function for short-distance communication with the display device 200 and a portable terminal device 300. The display device 200 is a sheet-shaped touch screen spread over a substantially entire desk surface as a predetermined area, and structured to have a sheet-shaped liquid-crystal panel (omitted in the drawing) having a size identical to the desk surface, and a touch panel (omitted in the drawing) having the same shape and size and arranged and laminated on the liquid-crystal panel. The touch screen constituting the display device 200 may be of any type, such as a matrix switch type, a resistive film type, an electrostatic capacitance type, an electromagnetic induction type, or an infrared-ray insulating type. The display device (touch screen) 102 has a communication function for short-distance communication with the notebook PC 100.

When an arbitrary portable terminal device 300 is placed on the display device 200, the display device 200 detects that the portable terminal device 300 has been placed, and gives a terminal detection signal to the notebook PC 100. Then, in response to the terminal detection signal from the display device 200, the notebook PC 100 recognizes the portable terminal device 300 as an output target, and controls the display of the display device 200 such that display information associated with the portable terminal device 300 is displayed at a position near the portable terminal device 300. The customer and the worker face each other for service while viewing the display contents (reference) of the portable terminal device 300 placed on the display device 200. Here, when the portable terminal device 300 is placed on the display device 200, the notebook PC 100 transmits display information to the display device 200 such that this display information unique to the terminal is displayed at a position near the portable terminal device 300 on the display device 200.

The portable terminal device 300 is an output target when display information unique to the terminal is displayed at a position near the terminal, that is, an output target that is present outside the notebook PC 100, such as a tablet terminal, smartphone, or PDA (Personal Digital Assistant). When the portable terminal device 300 is placed at an arbitrary position on the display device 200 with display information such as a meeting reference being displayed on the output target (portable terminal device 300), the display device 200 detects, from the contact state, the contact position where the portable terminal device 300 has been placed (the presence position of the portable terminal device 300), and transmits the detected position to the notebook PC 100. Also, the portable terminal device 300 outputs and sends its own terminal identification information (terminal ID) to the notebook PC 100.

Note that, normally, the portable terminal device 300 outputs and sends its own terminal identification information (terminal ID) when it is on the display device 200. When the terminal ID is received from the portable terminal device 300, the notebook PC 100 identifies the portable terminal device 300 placed on the display device 200. When information regarding the presence position of the portable terminal device 300 is received from the display device 200, the notebook PC 100 identifies a position near the portable terminal device 300 (a position where the display information unique to the terminal is to be displayed), based on this presence position.

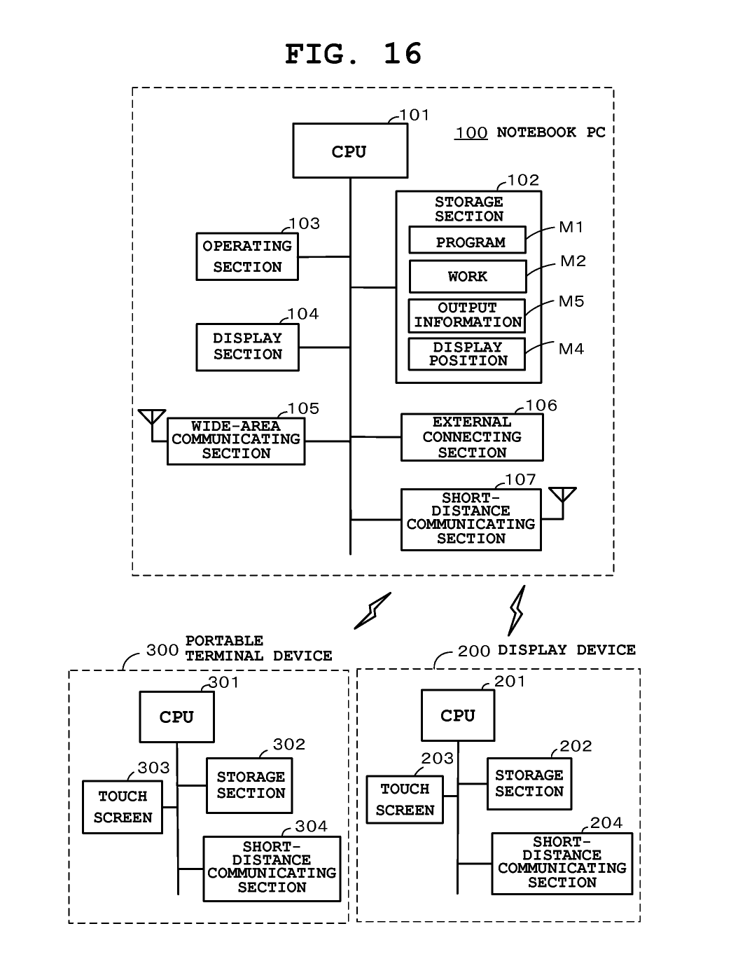

FIG. 16 is a block diagram showing basic components of the notebook PC 100, the display device 200, and the portable terminal device 300.

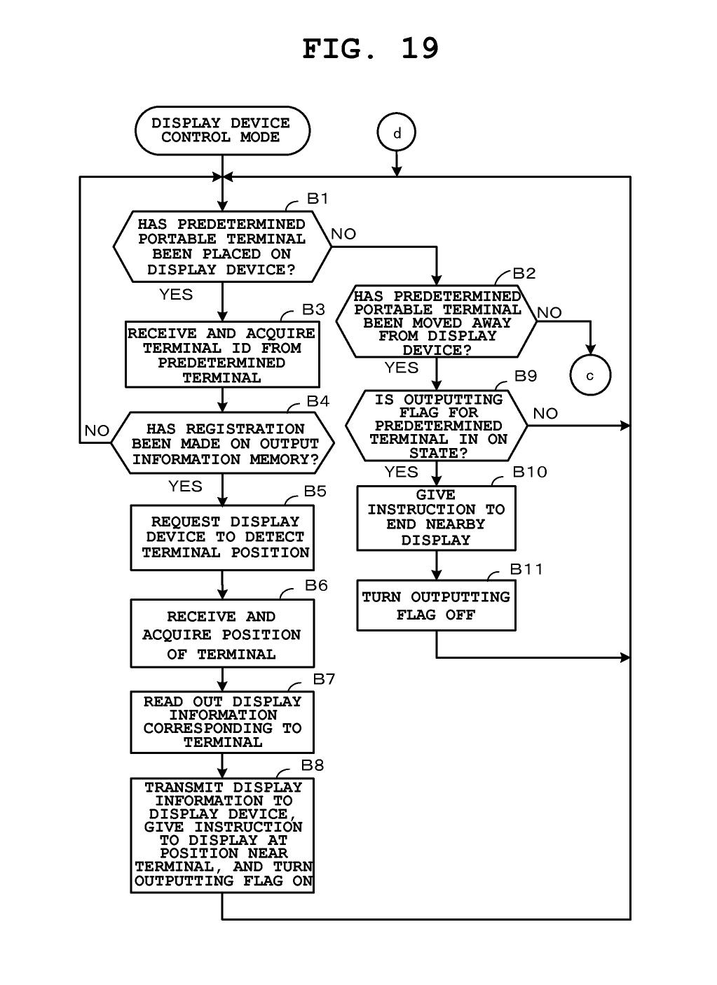

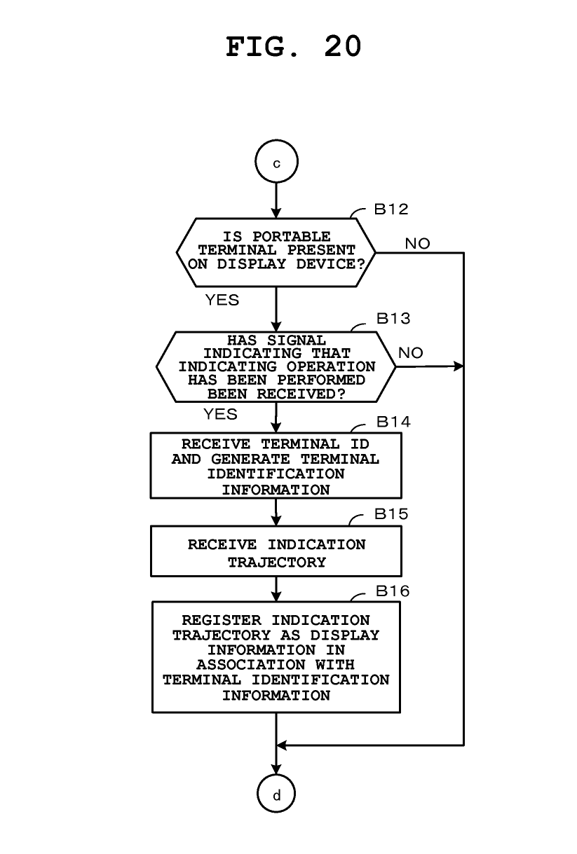

The notebook PC 100 has a CPU 101 as a main component. This CPU 101 is a central processing unit that controls the entire operation of the notebook PC 100 by following various programs in a storage section 102. The storage section 102 is constituted by, for example, a ROM, a flash memory, and the like, and has a program memory M1 that stores a program for achieving the present embodiment in accordance with an operation procedure depicted in FIG. 19 and FIG. 20, a work memory M2 that temporarily stores various data (such as clock time, timer measurement time, and flag) required in the notebook PC 100, an output information memory M5 described later, and the like.

The CPU 101 has an operating section 103, a display section 104, a wide-area communicating section 105, an external connecting section 106, a short-distance communicating section 107 and the like connected thereto as input/output devices. This CPU 101 controls each of the input/output devices by following an input/output program. The short-distance communicating section 107 is a communication interface connected for communication with the display device 200 or the portable terminal device 300 by wireless LAN (Local Area Network), Bluetooth (registered trademark) communication, or the like.

The display device 200 has a CPU 201 as a main component. This CPU 201, which controls the entire operation of the display device 200 in accordance with various programs in a storage section 202, has a touch screen 203, a short-distance communicating section 204, and the like connected thereto as input/output devices. The CPU 201 controls each of the input/output devices by following an input/output program. The touch screen 203 may be of any type, such as a matrix switch type, a resistive film type, an electrostatic capacitance type, an electromagnetic induction type, or an infrared-ray insulating type. The short-distance communicating section 204 is a communication interface connected for communication with the notebook PC 100 by wireless LAN, Bluetooth (registered trademark) communication, or the like.

The portable terminal device 300 has a CPU 301 as a main component. This CPU 301, which controls the entire operation of the portable terminal device 300 in accordance with various programs in a storage section 302, has a touch screen 303, a short-distance communicating section 304, and the like connected thereto as input/output devices. This CPU 301 controls each of the input/output devices by following an input/output program. The short-distance communicating section 304 is a communication interface connected for communication with the notebook PC 100 by wireless LAN, Bluetooth (registered trademark) communication, or the like.

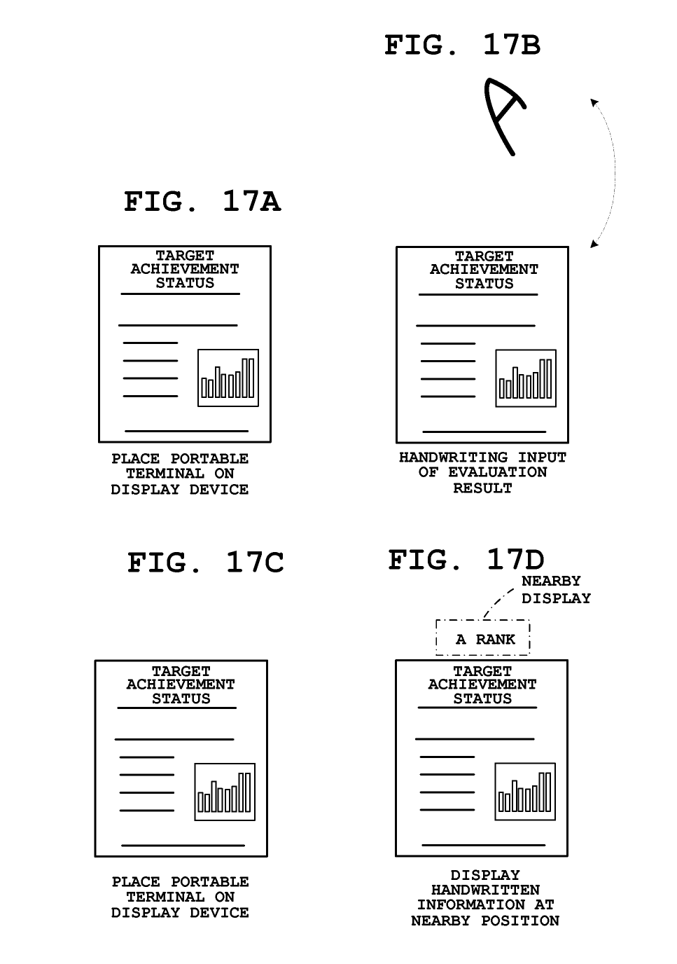

FIG. 17A to FIG. 17D are diagrams for describing display contents when the portable terminal device 300 is on the display device 200.

FIG. 17A shows a state where the portable terminal device 300 itself is displaying information with it being placed on the display device 200. In the shown example, the portable terminal device 300 displaying a target achievement status of a sales person (user) has been placed on the display device 200. FIG. 17B shows a case where “A” indicating an upper rank as a sales evaluation result has been inputted by handwriting on an arbitrary position on the display device 200 in the state of FIG. 17A. When information inputted by handwriting while the portable terminal device 300 is on the display device 200 is received and acquired from the display device 200, the notebook PC 100 stores the input information (handwritten information) in the output information memory M5 as display information, in association with the portable terminal device 300.

FIG. 17C shows a case where the portable terminal device 300 having the display contents depicted in FIG. 17A is placed again on the display device 200 after the handwriting input. The notebook PC 100 identifies the portable terminal device 300, reads out the display information (handwritten input information) corresponding thereto from the output information memory M5, transmits the read display information to the display device 200, and causes the display information to be displayed near the portable terminal device 300. FIG. 17D shows a state where “A” rank has been additionally displayed as handwritten input information (sales evaluation result) at a position near the portable terminal device 300. In this embodiment, as handwritten input information, sales evaluation has been exemplarily described, and therefore a character string “rank” is additionally displayed following the input information “A”.

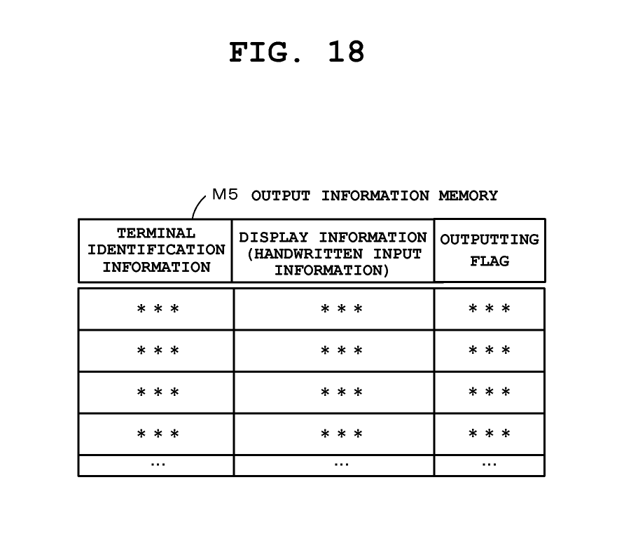

FIG. 18 is a diagram for describing the output information memory M5.

The output information memory M5, which stores and manages display information in association with a plurality of output targets (portable terminal devices 300), has items of “terminal identification information”, “display information (handwritten input information)”, and “outputting flag”. “Terminal identification information” is ID information for identifying each of the portable terminal devices 300, and “display information (handwritten input information)” is information inputted by handwriting on the display device 200. “Outputting flag” is a flag indicating that handwritten input information is being displayed at a position near the portable terminal device 300.

FIG. 19 and FIG. 20 show a flowchart that is started when “display device control mode” for controlling the display of the display device 200 is selected. In the following descriptions, the characteristic operation of the third embodiment is specifically described with reference to FIG. 17A to FIG. 17D.

First, the CPU 101 of the notebook PC 100 judges whether a predetermined portable terminal device 300 has been placed on the display device 200 (Step B1 of FIG. 19) and judges whether this portable terminal device 300 has been moved away from the display device 200 (Step B2). Here, when some object is placed, the CPU 201 of the display device 200 detects, from the shape and size of the contact state, that the predetermined portable terminal device 300 has been placed. When some object is moved away therefrom, the CPU 201 detects, from the shape and size of the contact state when this object is in contact thererwith, that the predetermined portable terminal device 300 has been moved away. Then, the CPU 201 transmits a detection signal to the notebook PC 100.

When a detection signal indicating that the predetermined portable terminal device 300 has been placed on the display device 200 or a detection signal indicating that the portable terminal device 300 has been moved away is not received (NO at Steps B1 and B2), the CPU 101 of the notebook PC 100 proceeds to the flow of FIG. 20 and judges whether the portable terminal device 300 is present on the display device 200 (Step B12). In this case, since the portable terminal device 300 is not present on the display device 200 (NO at Step B12), the CPU 101 returns to Step B1 of FIG. 19.

When the portable terminal device 300 has been placed on the display device 200 as depicted in FIG. 17A (YES at Step B1), the CPU 101 receives a terminal ID outputted and sent from the portable terminal device 300 (Step B3). Then, based on the received terminal ID, the CPU 101 searches “terminal identification information” in the output information memory M5 and judges whether this terminal ID has been registered (Step B4). Here, the terminal ID has not been registered (NO at Step B4), and therefore the CPU 101 returns to Step B1. Then, the CPU 101 detects that the portable terminal device 300 is present on the display device 200 (YES at Step B12 of FIG. 20), and therefore proceeds to Step B13 to judge whether a signal indicating that an indicating operation has been performed has been received from the display device 200.

When an indicating operation has not been performed on the display device 200, that is, when a signal indicating that an indicating operation has been performed has not been received (NO at Step B13), the CPU 101 returns to Step B1 of FIG. 19. When an indicating operation has been performed on the display device 200 as depicted in FIG. 17B, that is, when a signal indicating that an indicating operation has been performed has been received (YES at Step B13), the CPU 101 proceeds to Step B14 to receive the terminal ID outputted and sent from the portable terminal device 300 and generate terminal identification information (Step B14). Then, the CPU 101 receives an indication trajectory from the display device 200 (Step B15), and registers the terminal ID and the indication trajectory (handwritten input information) in “terminal identification information” and “display information” in the output information memory M5 (Step B16). Then, the CPU 101 returns to Step B1 of FIG. 19.

When the portable terminal device 300 is moved away from the display device 200 after the handwritten input information is registered as described above, the CPU 101 detects this movement at the above-described Step B2, and then proceeds to the next Step B9 to judge whether “outputting flag” corresponding to the portable terminal device 300 is in an ON state, with reference to the output information memory M5. In this case, “outputting flag” is not in an ON state (NO at Step B9), and therefore the CPU 101 returns to the above-described Step B1.

Then, when the portable terminal device 300 is placed again on the display device 200 as depicted in FIG. 17C (YES at Step B1), since the terminal ID received at the next Step B3 has been registered on the output information memory M5 (YES at Step B4), the CPU 101 of the notebook PC 100 requests the display device 200 to detect the terminal position (Step B5). Then, the CPU 201 of the display device 200, which has received the request to detect the terminal position, detects the contact position where the portable terminal device 300 has been placed (the presence position of the portable terminal device 300) based on the contact state of the portable terminal device 300. Here, the CPU 201 of the display device 200 detects, with a reference point (for example, an upper-left corner) in the display device 200 as a starting point, the center or one corner of the contact surface of the portable terminal device 300 as a position where the portable terminal device 300 is present (position in a plane coordinate system).

When information regarding the terminal position detected by the display device 200 is received (Step B6), the CPU 101 of the notebook PC 100 reads out “display information (handwritten input information)” of the terminal from the output information memory M5 (Step B7), and transmits the received information regarding the terminal position and the handwritten input information to the display device 200 so as to instruct the display device 200 to perform display at a position near the portable terminal device 300 and turn on “outputting flag” corresponding to the terminal ID (Step B8). As a result, the handwritten input information is displayed on the display device 200 at the position near the portable terminal device 300 as depicted in FIG. 17D. In this case, the character string “rank” is additionally displayed following the handwritten input information “A”, as described above.

Then, when the portable terminal device 300 is moved away from the display device 200, the CPU 101 detects this movement at Step B2, and then proceeds to Step B9. In this case, since “outputting flag” is in an ON state (YES at Step B9), the CPU 101 proceeds to the next Step B10 and instructs the display device 200 to end the nearby display. As a result, the nearby display on the display device 200 is deleted. Then, after turning the “outputting flag” off (Step B11), the CPU 101 returns to Step B1.

As described above, the information output control device (notebook PC) 100 in the third embodiment includes the output information memory M5 which stores information (handwritten input information) inputted while an output target (portable terminal device 300) is in an external predetermined area (display device 200), in association with the portable terminal device 300. When the portable terminal device 300 is placed again on the display device 200, the handwritten input information stored in association with the portable terminal device 300 is read out from the output information memory M5 for reproduction output. As a result of this configuration, handwritten information inputted by associating the portable terminal device 300 and the display device 200 where the portable terminal device 300 is placed can be reproduced and outputted on condition of this association.

Also, when information regarding the presence position of the portable terminal device 300 on the display device 200 is received and acquired, the notebook PC 100 determines a position for reproduction output on the display device 200 based on this presence position, and performs reproduction output at the determined output position. As a result of this configuration, even when the portable terminal device 300 is placed at an arbitrary position on the display device 200, reproduction output can be performed at this position of the portable terminal device 300.

In the above-described third embodiment, input information handwritten on the display device (touch screen) 200 is registered on the output information memory M5. However, a configuration may be adopted in which captured images showing the motion of a finger or a pen are analyzed, handwritten information is generated from its indication trajectory and registered on the output information memory M5.

Also, in the above-described third embodiment, the portable terminal device 300 has been shown as an example of the output target of the present invention. However, the output target may be a touch screen or other display devices, or may be a simple object such as a magazine, a notebook, an object, an ornament, or a piece of paper.

Moreover, in the above-described third embodiment, the display device 200 is a touch screen. When some object is placed on the display device 200, whether the portable terminal device 300 has been placed and the presence position of the portable terminal device 300 is detected based on the shape and size of the contact state. However, a configuration may be adopted in which whether the portable terminal device 300 has been placed and the presence position of the portable terminal device 300 are detected by captured images of the display device 200 being analyzed. Alternatively, a configuration may be adopted in which a plurality of (for example, three or four) short-distance communicating sections (for example, Bluetooth (registered trademark) communicating sections or RF tag communicating sections) are arranged at predetermined positions on a desk and, when each communicating section receives an electric wave sent from an output target, the information output control device acquires a reception signal from each communicating section and detects the presence position of the output target by the calculation of radio field intensity and based on the principles of triangulation.

Furthermore, in the above-described embodiments, the present invention has been applied in a projector device or a notebook PC as an information output control device. However, the present invention is not limited thereto and can be applied to, for example, a PDA (Personal Digital Assistant), a tablet terminal device, a portable telephone such as a smartphone, and an electronic game machine.

Still further, the “devices” or the “sections” in the above-described embodiments are not required to be in a single housing and may be separated into a plurality of housings by function. In addition, the steps in the above-described flowcharts are not required to be processed in time-series, and may be processed in parallel, or individually and independently.

While the present invention has been described with reference to the preferred embodiments, it is intended that the invention be not limited by any of the details of the description therein but includes all the embodiments which fall within the scope of the appended claims.

What is claimed is:

1. An information output control device which outputs display information, comprising:
a display information storage section which stores display information in association with a display target which is present outside the information output control device;
an identifying section which identifies the display target which is present in a predetermined area;
a first acquiring section which reads out and acquires the display information associated with the display target identified by the identifying section, from the display information storage section;
a second acquiring section which acquires a position of the display target present in the predetermined area; and
a display control section which controls output of the display information such that the display information acquired by the first acquiring section is displayed in association with the display target present at the position acquired by the second acquiring section.

2. The information output control device according to claim 1, wherein the display control section performs control to end the output of the display information when the display target is identified as not being present in the predetermined area by the identifying section.

3. The information output control device according to claim 1, further comprising:
a display information generating section which detects an indicating operation targeted for the display target and generates information in accordance with an indication trajectory as the display information,
wherein the display information storage section stores the display information generated by the display information generating section in association with the display target.

4. The information output control device according to claim 1, further comprising:
an extracting section which extracts the display information from an image acquired by the display information displayed on the display target being captured,
wherein the display information storage section stores the display information extracted by the extracting section in association with the display target.

5. The information output control device according to claim 1, wherein the display information storage section stores information indicating a display position in association with the display target so that the display information is displayed in association with the display target, and
wherein the display control section outputs the display information such that the display information is displayed at the display position.

6. The information output control device according to claim 5, wherein the display position is a position on the display target or a position near the display target so that the display information is displayed in association with the display target, and
wherein the display information storage section stores information indicating the display position arbitrarily set by a user operation, in association with the display target.

7. The information output control device according to claim 1, further comprising:
an identification information generating section which generates identification information for identifying the display target from an image acquired by the display target being captured,
wherein the display information storage section stores the identification information generated by the identification information generating section in association with the display information,
wherein the identifying section identifies the identification information of the display target from the captured image of the display target present in the predetermined area, and
wherein the first acquiring section reads out and acquires the display information associated with the identification information identified by the identifying section, from the display information storage section.

8. A display method for displaying display information in association with a display target, comprising:
a storing step of storing display information in a display information storage section in association with a plurality of display targets;
an identifying step of identifying a display target which is present in a predetermined area;
a first acquiring step of reading out and acquiring display information associated with the display target identified in the identifying step, from the display information storage section;
a second acquiring step of acquiring a position of the display target present in the predetermined area; and
a display control step of controlling output of the display information such that the display information acquired in the first acquiring step is displayed in association with the display target present at the position acquired in the second acquiring step.

9. An information output control device which outputs information, comprising:
an input information acquiring section which acquires input information;
an identifying section which identifies a predetermined output target placed in a predetermined area outside the information output control device;
an information storage section which stores the input information acquired by the input information acquiring section while the output target identified by the identifying section is present in the predetermined area, in association with the output target; and
an output control section which reads out the input information stored in association with the output target from the information storage section, and performs reproduction output of the input information, when the output target is placed again in the predetermined area.

10. The information output control device according to claim 9, wherein the output control section performs control to end the reproduction output when the output target is identified as not being present in the predetermined area by the identifying section.

11. The information output control device according to claim 9, further comprising:
a judging section which judges in which direction or at which position the input information acquired by the input information acquiring section has been inputted with reference to the output target in the predetermined area,
wherein the information storage section stores a result acquired by judgment by the judging section as information indicating an input source, in association with the output target, and
wherein the output control section determines a direction or a position for the reproduction output based on the information indicating the input source, and performs the reproduction output with the determined direction or position as an output destination.

12. The information output control device according to claim 11, wherein the output control section, when determining the output destination based on the information indicating the input source, determines a direction or position identical to an input direction or position, a direction or position opposite to the input direction or position, or an arbitrarily set direction or position as the output destination.

13. The information output control device according to claim 9, further comprising:
a position acquiring section which acquires a presence position of the output target in the predetermined area,
wherein the output control section determines a position for the reproduction output based on the presence position of the output target acquired by the position acquiring section, and performs the reproduction output at the determined position for the reproduction output.

14. The information output control device according to claim 9, further comprising:
an identification information generating section which generates identification information for identifying the output target,
wherein the information storage section stores the identification information generated by the identification information generating section, in association with information inputted by an input section,
wherein the identifying section identifies the identification information from the output target present in the predetermined area, and
wherein the output control section reads out the information associated with the identification information identified by the identifying section, from the information storage section, and performs the reproduction output.

15. An information display control device which controls display in a predetermined area, comprising:
a display information storage section which stores display information in association with a display target which is present outside the information display control device;
an identifying section which identifies the display target placed on a display device in the predetermined area;
an acquiring section which reads out and acquires the display information associated with the display target identified by the identifying section, from the display information storage section; and
a display control section which controls display on the display device such that the display information acquired by the acquiring section is displayed at a position near the display target.

16. The information display control device according to claim 15, wherein the display control section performs control to end the display at the position near the display target when the display target is identified as not being present on the display device by the identifying section.

17. The information display control device according to claim 15, further comprising:
a display information generating section which detects an indicating operation targeted for the display target and generates information in accordance with an indication trajectory as the display information,
wherein the display information storage section stores the display information generated by the display information generating section in association with the display target.

18. The information display control device according to claim 15, further comprising:
a display information receiving section which receives display information displayed on the display target,
wherein the display information storage section stores the display information received by the display information receiving section, in association with the display target.

19. The information display control device according to claim 15, wherein the display information storage section stores information indicating a display position of the display information near the display target, in association with the display target, and
wherein the display control section controls display of the display information such that the display information is displayed at the display position.

20. The information display control device according to claim 15, wherein the display information storage section stores the display information in association with identification information for identifying the display target, and
wherein the identifying section identifies the display target by receiving the identification information for identifying the display target from the display target.
